(19) United States
(12) Patent Application Publication
(10) Pub. No.: US 2025/0130763 A1
(43) Pub. Date: Apr. 24, 2025

(54) DISPLAY APPARATUS, PLAYBACK APPARATUS

(71) Applicant: HISENSE VISUAL TECHNOLOGY CO., LTD., Qingdao (CN)

(72) Inventors: Yingxin ZHOU, Qingdao (CN); Kun YANG, Qingdao (CN); Zijing DENG, Qingdao (CN); Cong WANG, Qingdao (CN)

(21) Appl. No.: 19/001,305

(22) Filed: Dec. 24, 2024

Related U.S. Application Data
(63) Continuation of application No. PCT/CN2023/093107, filed on May 9, 2023.

(30) Foreign Application Priority Data
Jun. 30, 2022 (CN) 202210770156.2
Jun. 30, 2022 (CN) 202210771003.X

(51) Int. Cl. G06F 3/16; G06F 3/0482; H04L 12/18; H04W 76/40

(52) U.S. Cl. CPC G06F 3/165; G06F 3/0482; H04L 12/185; H04W 76/40

(57) ABSTRACT

A display apparatus includes: a display; a user input interface; a communicating device; a memory, configured to store computer instructions and data associated with the display and the communicating device; and one or more processor, connected with the display, the user input interface, the communicating device and the memory, and configured to execute the computer instructions to cause the display apparatus to: in response to a target input command received from the user input interface, obtain transmission information of a target audio stream indicated by a target identifier; and send the transmission information to a target playback apparatus, so that the target playback apparatus receives target broadcast isochronous stream, BIS, data broadcasted by the display apparatus from the target transmission channel according to the transmission information.

### CROSS-REFERENCE TO RELATED APPLICATIONS

This application is a continuation application of International Application No. PCT/CN2023/093107, filed on May 9, 2023, which claims priorities to Chinese Patent Application No. 202210771003.X, filed on Jun. 30, 2022; and Chinese Patent Application No. 202210770156.2, filed on Jun. 30, 2022, all of which are hereby incorporated by reference in their entireties.

### TECHNICAL FIELD

The disclosure relates to the field of Bluetooth communication technology, and particularly to a display apparatus, a playback apparatus, a control device, and data transmission methods.

### BACKGROUND

In Bluetooth of low energy, when an audio stream is received through a broadcast isochronous stream (BIS), an audio stream needs to be selected by a playback apparatus (an audio can be played according to the audio stream selected by the playback apparatus). However, when there is no screen on the playback apparatus, it is impossible to select the audio stream through the playback apparatus. Therefore, an auxiliary apparatus needs to be added in addition to an audio source apparatus (such as a display apparatus) and the playback apparatus to assist the playback apparatus in selecting an audio stream.

However, addition of the auxiliary device will not only increase the cost, but also complicate a user's operation, resulting in poor user experience.

### SUMMARY

A display apparatus according to embodiments of the disclosure includes: a display, configured to present an image from a broadcast system and/or a network, and/or present a user interface; a user input interface, configured to receive a command from a user; a communicating device, configured to communicate with an external device; a memory, configured to store computer instructions and data associated with the display and the communicating device; and one or more processor, connected with the display, the user input interface, the communicating device and the memory, and configured to execute the computer instructions to cause the display apparatus to: in response to a target input command received from the user input interface, obtain transmission information of a target audio stream indicated by a target identifier, where the transmission information is configured to indicate a target transmission channel corresponding to the target audio stream; and send the transmission information to a target playback apparatus, so that the target playback apparatus receives target broadcast isochronous stream (BIS) data broadcasted by the display apparatus from the target transmission channel according to the transmission information, where the target BIS data is configured to indicate the target audio stream, the display is configured to present at least one identifier, each identifier is configured to indicate an audio stream, and the at least one identifier is obtained from an application providing an audio stream; where the user input interface is configured to receive a target input command from the user for the target identifier in the at least one identifier, and the target input command is configured to determine an audio stream to be played by the target playback apparatus.

A playback apparatus according to embodiments of the disclosure includes: one or more processor, configured to: receive transmission information sent from a display apparatus, where the transmission information is configured to indicate a target transmission channel corresponding to a target audio stream, the transmission information is transmission information of the target audio stream indicated by a target identifier obtained by the display apparatus in response to a target input command, the target input command is an input command received by the display apparatus from a user for a target identifier in at least one identifier, the target input command is configured to determine an audio stream to be played by a target playback apparatus, the at least one identifier is obtained by the display apparatus from an application providing an audio stream, and each identifier is configured to indicate an audio stream; and receive target broadcast isochronous stream (BIS) data sent from the display apparatus from the target transmission channel according to the transmission information, where the target BIS data is configured to indicate the target audio stream.

A control device according to embodiments of the disclosure includes: a communicating device, configured to send a broadcast packet to a display apparatus in a case that the control device supports a broadcast assistant service, where the broadcast packet carries a universally unique identifier (UUID) of the broadcast assistant service; establish a broadcast source information link with the display apparatus; obtain a broadcast source scanning result by performing broadcast source scanning; and send the broadcast source scanning result to the display apparatus through the broadcast source information link.

A data transmission method for a display apparatus according to embodiments of the disclosure includes: presenting at least one identifier, where each identifier is configured to indicate an audio stream, and the at least one identifier is obtained from an application providing an audio stream; receiving a target input command from a user for a target identifier in the at least one identifier, where the target input command is configured to determine an audio stream to be played by a target playback apparatus; in response to the target input command, obtaining transmission information of a target audio stream indicated by the target identifier, where the transmission information is configured to indicate a target transmission channel corresponding to the target audio stream; and sending the transmission information to the target playback apparatus, so that the target playback apparatus receives target broadcast isochronous stream (BIS) data broadcasted by the display apparatus from the target transmission channel according to the transmission information, where the target BIS data is configured to indicate the target audio stream.

A data transmission method for a playback apparatus according to embodiments of the disclosure includes: receiving transmission information sent from a display apparatus, where the transmission information is configured to indicate a target transmission channel corresponding to a target audio stream, the transmission information is transmission information of the target audio stream indicated by a target identifier obtained by the display apparatus in response to a target input command, the target input command is an input command received by the display apparatus from a user for a target identifier in at least one identifier, the target input command is configured to determine an audio stream to be played by a target playback apparatus, the at least one identifier is obtained by the display apparatus from an application providing an audio stream, and each identifier is configured to indicate an audio stream; and receiving target broadcast isochronous stream (BIS) data sent from the display apparatus from the target transmission channel according to the transmission information, where the target BIS data is configured to indicate the target audio stream.

A data transmission method for a control device according to embodiments of the disclosure includes: sending a broadcast packet to a display apparatus in a case that a broadcast assistant service is supported; where the broadcast packet carries a universally unique identifier (UUID) of the broadcast assistant service; establishing a broadcast source information link with the display apparatus; obtaining a broadcast source scanning result by performing broadcast source scanning; and sending the broadcast source scanning result to the display apparatus through the broadcast source information link.

### BRIEF DESCRIPTION OF FIGURES

FIG. 1 is an operation scenario between a control apparatus and a display apparatus according to some embodiments.

FIG. 2 is a block diagram of a hardware configuration of a control device 100 according to some embodiments.

FIG. 3 is a block diagram of a hardware configuration of a display apparatus 200 according to some embodiments.

FIG. 4 is a diagram of a software configuration in a display apparatus 200 according to some embodiments.

FIG. 5 is a schematic diagram of at least one identifier presented by a display apparatus according to some embodiments.

FIG. 6 is a first schematic diagram of a display apparatus broadcasting BIS data and a playback apparatus receiving corresponding BIS data according to some embodiments.

FIG. 7 is a second schematic diagram of a display apparatus broadcasting BIS data and a playback apparatus receiving corresponding BIS data according to some embodiments.

FIG. 8 is a third schematic diagram of a display apparatus broadcasting BIS data and a playback apparatus receiving corresponding BIS data according to some embodiments.

FIG. 9 is a first flow chart of a data transmission method according to some embodiments.

FIG. 10 is a second flow chart of a data transmission method according to some embodiments.

FIG. 11 is a third flow chart of a data transmission method according to some embodiments.

FIG. 12 is a fourth flow chart of a data transmission method according to some embodiments.

FIG. 13 is a fifth flow chart of a data transmission method according to some embodiments.

FIG. 14 is a sixth flow chart of a data transmission method according to some embodiments.

FIG. 15 is a seventh flow chart of a data transmission method for a display apparatus according to embodiments of the disclosure.

FIG. 16 is a schematic diagram of a display interface of a control device according to embodiments of the disclosure.

FIG. 17 is a schematic diagram of another display interface of a control device according to embodiments of the disclosure.

FIG. 18 is an eighth flow chart of a data transmission method for a display apparatus according to embodiments of the disclosure.

FIG. 19 is a ninth flow chart of a data transmission method for a display apparatus according to embodiments of the disclosure.

FIG. 20 is a schematic diagram of a display interface of a display apparatus according to embodiments of the disclosure.

FIG. 21 is a tenth flow chart of a data transmission method for a display apparatus according to embodiments of the disclosure.

FIG. 22 is a schematic diagram of a display interface of a control device according to embodiments of the disclosure.

FIG. 23 is an eleventh flow chart of a data transmission method for a display apparatus according to embodiments of the disclosure.

FIG. 24 is a schematic diagram of a display interface of a display apparatus according to embodiments of the disclosure.

FIG. 25 is a twelfth flow chart of a data transmission method for a display apparatus according to embodiments of the disclosure.

FIG. 26 is a thirteenth flow chart of a data transmission method for a display apparatus according to embodiments of the disclosure.

### DETAILED DESCRIPTION

In order to make purposes and embodiments of the disclosure clearer, embodiments of the disclosure will be described clearly and completely below in combination with the accompanying drawings in embodiments of the disclosure. Obviously, the described embodiments are some but not all embodiments of the disclosure.

It should be noted that the brief description of the terms in the disclosure is only for the convenience of understanding embodiments described hereafter, and is not intended to limit embodiments of the disclosure. Unless otherwise specified, these terms should be understood according to the ordinary and plain meanings.

The display apparatus according to embodiments of the disclosure may have various implementation forms, for example, the display apparatus may be a television, a smart television, a laser projection device, a monitor, an electronic bulletin board, an electronic table, a mobile phone, a tablet computer, a notebook computer, a palmtop computer, an on-vehicle electronic device, or the like.

FIG. 1 is a schematic diagram of an operation scenario between a display apparatus and a control apparatus according to embodiments. The control apparatus incudes a smart device or a control device. As shown in FIG. 1, a user may operate the display apparatus 200 through the smart device 300 or the control device 100.

In some embodiments, the control device 100 may be a remote control, and communication between the remote control and the display apparatus includes at least one of infrared protocol communication or Bluetooth protocol communication, or other short-range communication methods.

The display apparatus 200 is controlled wirelessly or by wired methods. The user may control the display apparatus 200 by inputting a user command through at least one of a button on the remote control, a voice input, a control panel input, etc.

In some embodiments, a smart device 300 (such as a mobile terminal, a tablet computer, a computer, a notebook computer, etc.) may also be used to control the display apparatus 200. For example, the display apparatus 200 is controlled using an application running on the smart device.

In some embodiments, the display apparatus may not receive commands using the smart device or the control device described above. Instead, the user's control is received through touch, gesture, or the like.

In some embodiments, the display apparatus 200 may also be controlled by means other than the control device 100 and the smart device 300, for example, may directly receive a voice command control from a user via a module for obtaining a voice command provided inside the display apparatus 200, or may receive a voice command control from a user via a voice control device provided outside the display apparatus 200.

In some embodiments, the display apparatus 200 also performs data communication with a server 400. The display apparatus 200 may be allowed to perform communicative connection through a Local Area Network (LAN), a Wireless Local Area Network (WLAN), and other networks. The server 400 may provide various contents and interactions for the display apparatus 200.

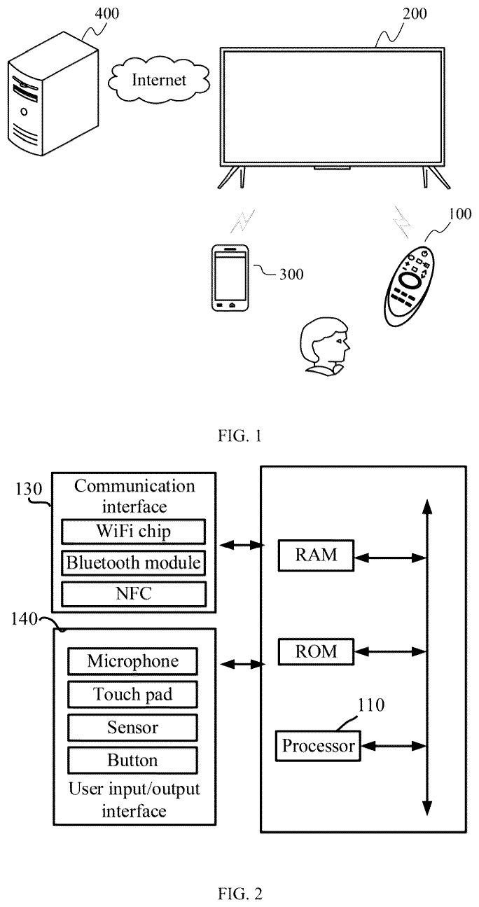

FIG. 2 is a block diagram of a configuration of a control device 100 according to embodiments. As shown in FIG. 2, the control device 100 includes one or more processor 110, a communication interface 130, a user input/output interface 140, a memory, and a power supply. The control device 100 can receive an input command from a user and convert an operation command into a command that can be recognized and responded by the display apparatus 200, playing an intermediary role for interaction between the user and the display apparatus 200.

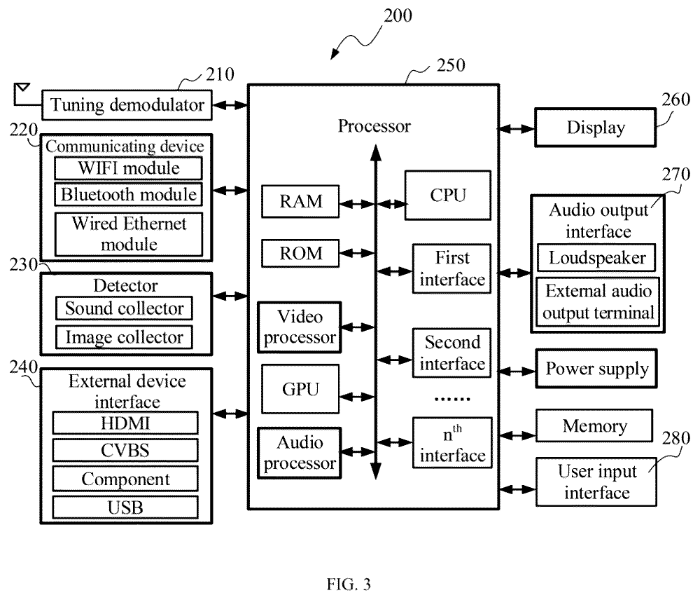

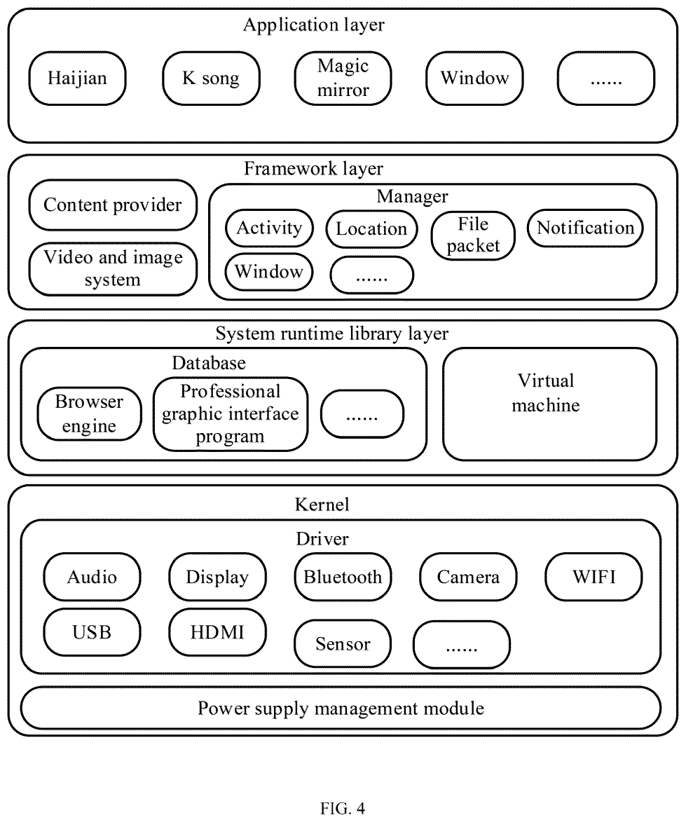

As shown in FIG. 3, the display apparatus 200 includes at least one of a tuning demodulator 210, a communicating device 220, a detector 230, an external device interface 240, one or more processor 250, a display 260, an audio output interface 270, a user interface 280, an external memory, or a power supply.

In some embodiments, the one or more processor includes a video processor, an audio processor, a graphics processor, RAM, ROM, a first interface to an n^{th} interface for input/output.

The display 260 includes a panel component for presenting an image, a driver component for driving image display, a component for receiving an image signal output from the one or more processor, and for presenting video content, image content, a menu manipulation interface, and a UI for user operation, etc.

The display 260 may be a liquid crystal display, an OLED display, and a projection display, and may also be a projection device and a projection screen.

The communicating device 220 is a component for communicating with an external apparatus or server according to various types of communication protocols. For example, the communicating device may include at least one of a WIFI module, a Bluetooth module, a wired Ethernet module, other network communication protocol chip or near-field communication protocol chip, or an infrared receiver. The display apparatus 200 may send and receive control signals and data signals with the control device 100 or the server 400 through the communicating device 220.

The user interface 280 is configured to receive a control signal from the control device 100 (e.g., an infrared remote controller), and may also be configured to directly receive an input command from a user and convert an operation command into a command that can be recognized and responded by the display apparatus 200. The user interface 280 may be referred to as a user input interface.

The detector 230 is configured to collect a signal from an external environment or external interaction. For example, the detector 230 includes an optical receiver and a sensor for collecting ambient light intensity; or, the detector 230 includes an image collector, such as a camera, which may be configured to collect an external environment scenario, a user attribute, or a user interaction gesture, or the detector 230 includes a sound collector, such as a microphone, which is configured to receive external sound.

The external device interface 240 may include, but is not limited to, any one or more of a high-definition multimedia interface (HDMI), an analog or data high-definition component input interface (Component), a composite video broadcast signal (CVBS) input interface, a USB input interface (USB), or an RGB terminal, or may be a composite input/output interface formed by multiple interfaces mentioned above.

The tuning demodulator 210 receives broadcasting television signals through wired or wireless reception, and demodulates audio and video signals from multiple wireless/wired broadcasting television signals, such as Electronic Program Guide (EPG) data signals.

In some embodiments, the one or more processor 250 and the tuning demodulator 210 can be in different independent devices, that is, the tuning demodulator 210 can be in an external device of a primary device in which the control device 250 is located, such as an external set-top box, etc.

The one or more processor 250 controls the operation of the display apparatus and responds to the user operation through various software control programs stored in the memory (an internal memory or an external memory). The one or more processor 250 controls the overall operation of the display apparatus 200. For an example, in response to receiving a user command for selecting a UI object presented on the display 260, the one or more processor 250 can perform operations associated with the object selected based on the user command.

In some embodiments, the one or more processor includes at least one of a Central Processing Unit (CPU), a video processor, an audio processor, a Graphics Processing Unit (GPU), a Random Access Memory (RAM), a Read Only Memory (ROM), a first interface to an n^{th} interface for input/output, or a BUS.

The user can input user commands through a Graphical User Interface (GUI) presented on the display 260. Then, the user input interface receives the user commands through the GUI. Alternatively, the user can input user commands through inputting specified voice or gestures. Then, the user input interface receives the user commands through a sensor recognizing the voice or gestures.

Referring to FIG. 4, in some embodiments, the operating system of the display apparatus 200 is divided into four layers, from top to bottom, which are applications layer (application layer for short), application framework layer (framework layer for short), android runtime and system library layer (system runtime library layer for short) and kernel layer.

In some embodiments, the kernel layer is a layer between hardware and software. As shown in FIG. 4, the kernel layer includes at least one of following drivers: audio driver, display driver, Bluetooth driver, camera driver, WIFI driver, USB driver, HDMI driver, sensor driver (such as fingerprint sensor, temperature sensor, pressure sensor, etc.), or power supply driver, etc.

One display apparatus corresponding to one playback apparatus (target playback apparatus) is taken as an example for description. When one display apparatus corresponds to a plurality of playback apparatuses, interaction between each playback apparatus and the display apparatus is the same as interaction between the target playback apparatus and the display apparatus.

A display apparatus according to embodiments of the disclosure includes a display configured to present an image from a broadcast system and/or a network, and/or present a user interface; a user input interface configured to receive a command from a user; a communicating device configured to communicate with an external device; a memory configured to store computer instructions and data associated with the display and the communicating device; one or more processor connected with the display, the user input interface, the communicating device and the memory, and configured to execute the computer instructions to cause the display apparatus to: in response to a target input command received from the user input interface, obtain transmission information of a target audio stream indicated by a target identifier, where the transmission information is configured to indicate a target transmission channel corresponding to the target audio stream; and send the transmission information to a target playback apparatus, so that the target playback apparatus receives target broadcast isochronous stream (BIS) data broadcasted by the display apparatus from the target transmission channel based on the transmission information, where the target BIS data is configured to indicate the target audio stream, the display is configured to present at least one identifier, each identifier is configured to indicate an audio stream, and the at least one identifier is obtained from an application providing an audio stream; where the user input interface is configured to receive a target input command from the user for the target identifier in the at least one identifier, and the target input command is configured to determine an audio stream to be played by the target playback apparatus.

A playback apparatus according to embodiments of the disclosure includes one or more processor configured to: receive transmission information sent from a display apparatus, where the transmission information is configured to indicate a target transmission channel corresponding to a target audio stream, the transmission information is transmission information of the target audio stream indicated by a target identifier obtained by the display apparatus in response to a target input command, the target input command is an input command received by the display apparatus from a user for a target identifier in at least one identifier, the target input command is configured to determine an audio stream to be played by a target playback apparatus, the at least one identifier is obtained by the display apparatus from an application providing an audio stream, and each identifier is configured to indicate an audio stream; and receive target BIS data sent from the display apparatus from the target transmission channel according to the transmission information, where the target BIS data is configured to indicate the target audio stream.

It can be understood that the display apparatus presents at least one identifier, receives a target input command from a user for a target identifier in the at least one identifier, obtains transmission information of a target audio stream indicated by the target identifier in response to the target input command, and sends the transmission information to a target playback apparatus; the target playback apparatus receives the transmission information sent from the display apparatus, and receives target BIS data sent from the display apparatus from the target transmission channel according to the transmission information.

It can be understood that the at least one identifier presented by the display is obtained from the application providing the audio stream. In particular, only at least one identifier is obtained from the application providing the audio stream. Alternatively, at least one audio stream and at least one identifier (each identifier is configured to indicate an audio stream) are simultaneously obtained from the application providing the audio stream. Alternatively, at least one audio stream is obtained from the application providing the audio stream, and at least one identifier is determined according to the at least one audio stream.

In some embodiments of the disclosure, the at least one identifier is obtained from the application providing the audio stream. The at least one identifier may be identifiers of all audio streams in the application obtained from the application providing the audio streams. The at least one identifier may also be part of identifiers of all the audio streams in the application obtained from the application providing the audio stream (in this case, the at least one identifier may be determined based on a statistical history of playback of the audio stream selected by the user).

Each identifier is configured to uniquely indicate an audio stream. The identifier may be a name corresponding to the audio stream, and may also be an image corresponding to the audio stream, which is not limited in embodiments of the disclosure.

A target input command from a user for a target identifier in at least one identifier is received, and the target input command is configured to determine an audio stream to be played by a target playback apparatus. In other words, the user selects an audio stream to be played by the target playback apparatus from at least one identifier presented by the display apparatus (the audio stream corresponding to the identifier selected by the user may be played through the target playback apparatus).

When there are a plurality of playback apparatuses, the user may select at least two audio streams for the plurality of playback apparatuses. Different audio streams may be selected for the plurality of playback apparatuses, or the same audio stream may be selected for the plurality of playback apparatuses. The specific corresponding relationship between the playback apparatus and the audio stream is determined by the identifier selected by the user for each playback apparatus in the at least one identifier.

The at least one identifier may be presented on a current playing interface of the display apparatus (for example, presented in a floating manner on the current playing interface or presented in a pop-up window on the current playing interface, etc.), being more in line with use habits of the user. The at least one identifier may also be presented on other interfaces (such as interfaces dedicated to displaying the at least one identifier). The presentation region or manner of the at least one identifier is not limited in embodiments of the disclosure.

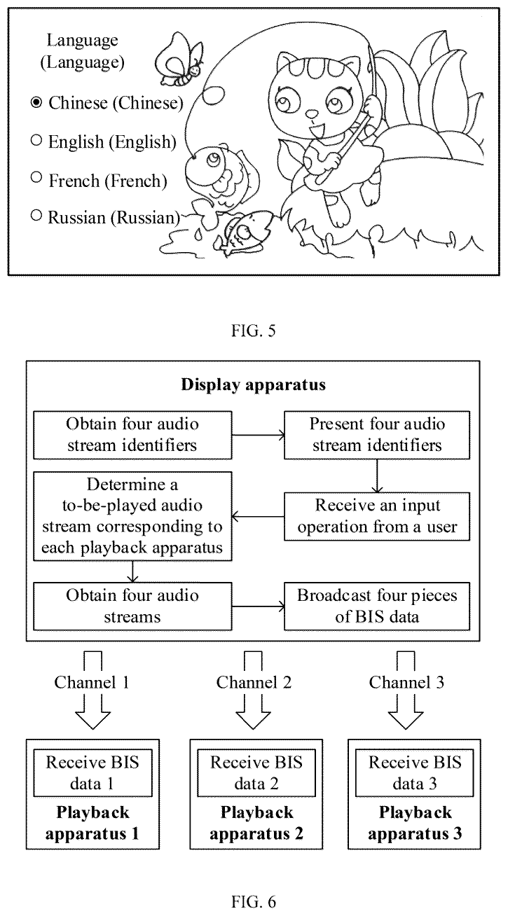

Taking the display apparatus as a television and the playback apparatus as an earphone as an example for illustration, the television and the earphone both have the Bluetooth function. As shown in FIG. 5, a video playback interface of the television presents identifiers of audio streams of four different languages (obtained from the application).

In a case, a television corresponds to an earphone, and the user selects a “Chinese” identifier for the earphone. The television sends transmission information of an audio stream corresponding to “Chinese” to the earphone, and then broadcasts audio streams of four different languages in a BIS mode. The earphone receives BIS data corresponding to “Chinese” through a transmission channel indicated in the transmission information.

In another case, a television corresponds to a plurality of earphones, and the user selects a “Chinese” identifier for an earphone 1, and selects an “English” identifier for an earphone 2. The television sends transmission information of an audio stream corresponding to “Chinese” to the earphone 1, sends transmission information of an audio stream corresponding to “English” the earphone 2, and then broadcasts audio streams of four different languages in a BIS mode. The earphone 1 receives BIS data corresponding to “Chinese” through a transmission channel indicated in the corresponding transmission information, and the earphone 2 receives BIS data corresponding to “English” through a transmission channel indicated in the corresponding transmission information.

In another case, a television corresponds to a plurality of earphones, and the user selects a “Chinese” identifier for an earphone 1, also selects the “Chinese” identifier for an earphone 2, and selects an “English” identifier for an earphone 3. The television sends transmission information of an audio stream corresponding to “Chinese” to the earphone 1 and the earphone 2, sends transmission information of an audio stream corresponding to “English” to the earphone 3, and then broadcasts audio streams of four different languages in a BIS mode. The earphone 1 and the earphone 2 receive BIS data corresponding to “Chinese” through a transmission channel indicated in the corresponding transmission information, and the earphone 3 receives BIS data corresponding to “English” through a transmission channel indicated in the corresponding transmission information.

In another case, a television corresponds to a plurality of earphones, and the user selects a “Chinese” identifier for an earphone 1, and also selects the “Chinese” identifier for an earphone 2. The television sends transmission information of an audio stream corresponding to “Chinese” to the earphone 1 and the earphone 2, and then broadcasts audio streams of four different languages in a BIS mode. The earphone 1 and the earphone 2 receive BIS data corresponding to “Chinese” through a transmission channel indicated in the corresponding transmission information.

It can be understood that the display apparatus sends the transmission information to the target playback apparatus, the target playback apparatus receives the transmission information sent from the display apparatus, and the target playback apparatus sends a response message to the display apparatus based on the received transmission information. The response message is configured to represent that the target playback apparatus receives the transmission information. The display apparatus receives the response message sent from the target playback apparatus.

In embodiments of the disclosure, the display apparatus presents at least one identifier, receives a target input command of a user for a target identifier in the at least one identifier, obtains transmission information of a target audio stream indicated by the target identifier in response to the target input command, and sends the transmission information to a target playback apparatus; the target playback apparatus receives the transmission information sent from the display apparatus, and receives target BIS data sent from the display apparatus from the target transmission channel according to the transmission information, and the target BIS data is configured to indicate a target audio stream. Therefore, an auxiliary apparatus for selecting the audio stream for the playback apparatus does not need to be added between the display apparatus and the playback apparatus, the selection of the corresponding audio stream for the playback apparatus may be implemented on the display apparatus and operated on the display apparatus, which is also more in line with the user's habits, simple operation and good user experience.

In some embodiments of the disclosure, the display apparatus sends the transmission information to the target playback apparatus through an asynchronous connection-oriented link (ACL) between the display apparatus and the target playback apparatus; the target playback apparatus receives the transmission information sent from the display apparatus through an asynchronous connection-oriented link (ACL) between the display apparatus and the target playback apparatus.

It can be understood that the transmission information may be sent through an ACL link, and the transmission information may also be sent through other links existing between the display apparatus and the playback apparatus (such as a Connected Isochronous Stream (CIS) link, etc.), which is not limited in embodiments of the disclosure.

It can be understood that for a plurality of playback apparatuses, a to-be-played audio stream corresponding to each playback apparatus in the plurality of playback apparatuses is determined according to an identifier selected by the user for each playback apparatus in the plurality of playback apparatuses on the display interface, and transmission information corresponding to each playback apparatus is determined according to the to-be-played audio stream corresponding to each playback apparatus. The display apparatus sends transmission information corresponding to each playback apparatus to each playback apparatus.

In embodiments of the disclosure, transmission information is sent to the target playback apparatus through an asynchronous connection-oriented link (ACL) between the display apparatus and the target playback apparatus. Therefore, before the display apparatus broadcasts the BIS data, the transmission information corresponding to the target audio stream is sent to the target playback apparatus, so that the target playback apparatus can accurately obtain the target BIS data according to the corresponding target transmission channel in the transmission information, to obtain the target audio stream according to the target BIS data and ensure that the playback apparatus can accurately obtain the selected audio stream to be played. Moreover, compared with that the display apparatus broadcasts transmission information, and the playback apparatus needs to monitor a broadcast message all the time, because the transmission information is sent through the ACL link, the playback apparatus does not need to continuously monitor the broadcast channel. Therefore, power of the playback apparatus can be saved, available time of the playback apparatus can be extended, and the user experience can be optimized.

In some embodiments of the disclosure, the transmission information is further configured to indicate a sampling rate, a bit rate, a broadcast packet length, and a broadcast packet interval. The display apparatus obtains the target BIS data by processing the target audio stream based on the sampling rate, the bit rate, the broadcast packet length, and the broadcast packet interval. The target playback apparatus receives the target BIS data sent from the display apparatus from the target transmission channel according to the transmission information, obtains the target audio stream by processing the target BIS data based on the sampling rate, bit rate, broadcast packet length and broadcast packet interval, and plays the target audio stream.

The display apparatus obtains the target audio stream from the application, encodes the target audio stream (the sampling rate and the bit rate are encoding and decoding parameters), divides the coded target audio stream into at least one BIS broadcast packet according to the broadcast packet length and broadcasts the BIS broadcast packet. An interval length between two adjacent BIS broadcast packets is the broadcast packet interval. A reverse operation to that of the display apparatus is performed on the target playback apparatus side, a BIS broadcast packet is received within each broadcast packet interval, a length of each BIS broadcast packet is the broadcast packet length, and the received at least one BIS broadcast packet is decoded (the sampling rate and the bit rate are encoding and decoding parameters) to obtain a target audio stream, and the target audio stream is played.

In embodiments of the disclosure, the transmission information is further configured to indicate a sampling rate, a bit rate, a broadcast packet length, and a broadcast packet interval. A display apparatus and a target playback apparatus process a target audio stream based on a sampling rate, a bit rate, a broadcast packet length, and a broadcast packet interval. Therefore, after receiving a target BIS broadcast packet, the target playback apparatus can accurately obtain a target audio stream according to the sampling rate, the bit rate, the broadcast packet length and the broadcast packet interval.

In some embodiments of the disclosure, the display apparatus processes the target audio stream based on transmission parameters to obtain the target BIS data, and the display apparatus broadcasts the target BIS data. The target playback apparatus receives the target BIS data sent from the display apparatus from the target transmission channel according to the transmission information, the target playback apparatus processes the target BIS data based on the transmission parameters to obtain a target audio stream, and plays the target audio stream. The transmission parameters include a sampling rate, a bit rate, a broadcast packet length and a broadcast packet interval. A transmission channel has a corresponding relationship with a transmission parameter, the transmission parameter can be determined according to the transmission channel, and transmission parameters of the different transmission channels may be the same or different.

In embodiments of the disclosure, the display apparatus and the target playback apparatus process the target audio stream based on the transmission parameters, the transmission parameters of each transmission channel are preset, and the transmission parameters do not need to be sent each time in the transmission information, which ensures that the target playback apparatus can accurately obtain the target audio stream, while reducing messages to be sent, and the execution efficiency of message interaction is improved.

The display apparatus of the disclosure provides three approaches to broadcast audio streams.

In an approach, the display apparatus obtains all audio streams from the application, broadcasts BIS data corresponding to all audio streams (i.e., broadcasts BIS data corresponding to each of all audio streams obtained from the application. Each playback apparatus receives BIS data corresponding to an audio stream selected by the user for the playback apparatus according to a corresponding channel, and then obtains a corresponding audio stream according to the received BIS data, as described with reference to FIG. 6.

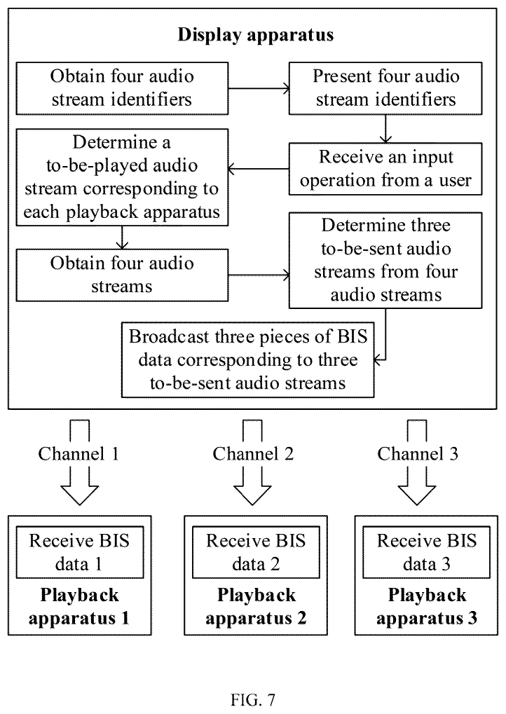

In another approach, the display apparatus obtains all audio streams from the application, then selects an audio stream corresponding to each playback apparatus according to an input command from a user, and broadcasts BIS data corresponding to the selected audio stream (that is, first obtains all audio streams, then selects part of the audio streams according to an input command from a user, and broadcasts BIS data corresponding to each audio stream in the part of audio streams). The playback apparatus receives BIS data corresponding to an audio stream selected by the user for the playback apparatus according to a corresponding channel, and then obtains a corresponding audio stream according to the received BIS data, as described with reference to FIG. 7.

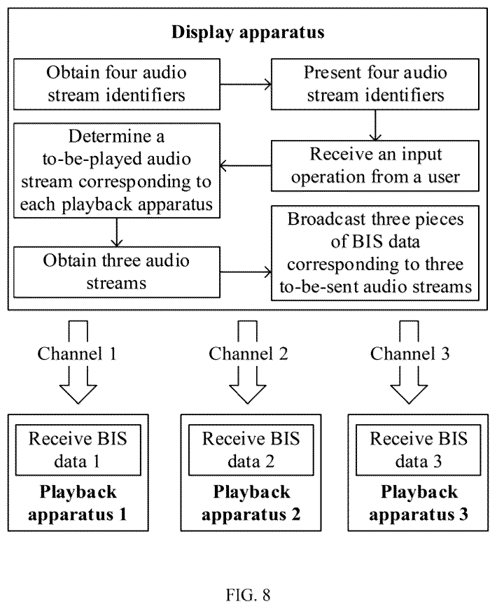

In yet another approach, the display apparatus determines an audio stream for each playback apparatus based on an input command from a user, obtains an audio stream determined for each playback apparatus from an application, and broadcasts the audio stream determined for each playback apparatus (i.e. determines the audio stream selected for each playback apparatus according to the input command from the user, obtains the audio stream only selected for each playback apparatus from the application, and broadcasts the BIS data corresponding to the audio stream selected for each playback apparatus). The playback apparatus receives BIS data corresponding to an audio stream selected by the user for the playback apparatus according to a corresponding channel, and then obtains a corresponding audio stream according to the received BIS data, as described with reference to FIG. 8.

Three cases are described in detail below.

In some embodiments of the disclosure, one or more processor of a display apparatus obtains at least one audio stream from an application, and each audio stream corresponds to an identifier; broadcasts at least one piece of BIS data, each piece of BIS data is configured to indicate one of at least one audio stream, the at least one piece of BIS data includes target BIS data, and different pieces of BIS data correspond to different transmission channels.

Each piece of BIS data includes at least one piece of BIS data packet. The number of BIS data packets included in each piece of BIS data is determined according to a size of the BIS data and a size of each piece of BIS data packet.

Each piece of BIS data includes at least one piece of BIS data packet. The display apparatus broadcasts one piece of BIS data packet. After receiving the BIS data packet, the playback apparatus sends a response message to the display apparatus, and the response message is configured to represent that the playback apparatus receives the BIS data packet.

Each piece of BIS data is configured to indicate one audio stream in at least one audio stream, different pieces of BIS data correspond to different transmission channels, that is, each piece of BIS data corresponds to an audio stream in the application, and different audio streams are sent on different channels. Therefore, for the playback apparatus, the BIS data is received through the transmission channel in the received transmission information sent from the display apparatus, and the audio stream selected for the playback apparatus can be obtained.

As shown in FIG. 6, FIG. 6 is a process that a display apparatus broadcasts BIS data and playback apparatuses receive corresponding BIS data. Taking one display apparatus and three playback apparatuses as an example, the display apparatus obtains four identifiers (each identifier indicates an audio stream) from the application. A playback apparatus 1 determines a to-be-played audio stream 1, a playback apparatus 2 determines a to-be-played audio stream 2, and a playback apparatus 3 determines a to-be-played audio stream 3, according to an input command from a user. The display apparatus obtains four audio streams from the application, and broadcasts four BIS data corresponding to the four audio streams. The playback apparatus 1 receives BIS data 1 (corresponding to the audio stream 1) through a channel 1, the playback apparatus 2 receives BIS data 2 (corresponding to the audio stream 2) through a channel 2, and the playback apparatus 3 receives BIS data 3 (corresponding to the audio stream 3) through a channel 3.

In embodiments of the disclosure, at least one audio stream is obtained from an application, and each audio stream corresponds to an identifier. At least one piece of BIS data is broadcasted, and each piece of BIS data is configured to indicate one of at least one audio stream. At least one piece of BIS data includes target BIS data, and different pieces of BIS data correspond to different transmission channels. All audio streams obtained from the application are broadcasted to at least one playback apparatus, and each of the at least one playback apparatus receives BIS data through a transmission channel in the received transmission information, so that an audio stream selected for each playback apparatus can be obtained, and each playback apparatus can play the selected audio stream.

In some embodiments of the disclosure, the one or more processor further obtains at least one audio stream from the application, and determines at least one to-be-sent audio stream from the at least one audio stream, where each to-be-sent audio stream audio stream is an audio stream to be played by a playback apparatus, and the at least one to-be-sent audio stream includes a target audio stream; broadcasts at least one piece of BIS data, where each piece of BIS data is configured to indicate one of at least one to-be-sent audio stream, at least one piece of BIS data includes target BIS data, and different pieces of BIS data correspond to different transmission channels.

It can be understood that at least one to-be-sent audio stream is determined from at least one audio stream, and each to-be-sent audio stream is an audio stream to be played by a playback apparatus, that is, a to-be-played audio stream is determined for each playback apparatus according to an input command from a user, where all to-be-played audio streams are to-be-sent audio streams. For example, four audio stream identifiers are presented on the display apparatus, the user selects an audio stream 1 corresponding to an identifier 1 for a playback apparatus 1, and selects an audio stream 2 corresponding to an identifier 2 for a playback apparatus 2, then to-be-sent audio streams are determined to be the audio stream 1 and the audio stream 2.

Illustratively, as shown in FIG. 7, FIG. 7 is another process that a display apparatus broadcasts BIS data and playback apparatuses receive corresponding BIS data. Taking one display apparatus and three playback apparatuses as an example, the display apparatus obtains four identifiers (each identifier indicates an audio stream) from the application. A playback apparatus 1 determines a to-be-played audio stream 1, a playback apparatus 2 determines a to-be-played audio stream 2, and a playback apparatus 3 determines a to-be-played audio stream 3, according to an input command from a user. The display apparatus obtains four audio streams from the application, determines three audio streams (i.e., an audio stream 1, an audio stream 2, and an audio stream 3) as to-be-sent audio streams in combination with the input command from the user, and broadcasts three pieces of BIS data corresponding to the three audio streams. The playback apparatus 1 receives BIS data 1 (corresponding to the audio stream 1) through a channel 1, the playback apparatus 2 receives BIS data 2 (corresponding to the audio stream 2) through a channel 2, and the playback apparatus 3 receives BIS data 3 (corresponding to the audio stream 3) through a channel 3.

In some embodiments of the disclosure, at least one audio stream is obtained from an application, and each audio stream corresponds to an identifier. At least one to-be-sent audio stream is determined from the at least one audio stream, each to-be-sent audio stream is an audio stream to be played by a playback apparatus, and at least one to-be-sent audio stream includes a target audio stream. At least one piece of BIS data is broadcasted, each piece of BIS data is configured to indicate one of at least one to-be-sent audio stream, at least one piece of BIS data includes target BIS data, and different pieces of BIS data correspond to different transmission channels. To broadcast at least one piece of BIS data corresponding to at least one audio stream, the display apparatus needs to process all audio streams in the at least one audio stream, and thus, the display apparatus side needs to process a large amount of data and a large number of resources are consumed. By obtaining an audio stream (a to-be-sent audio stream) to be played by at least one playback apparatus from at least one audio stream, the display apparatus only needs to process a to-be-processed audio stream to obtain at least one piece of BIS data, therefore, the resource consumption is reduced, and the data transmission efficiency between the display apparatus and the playback apparatus is improved.

In some embodiments of the disclosure, the one or more processor is further configured to obtain at least one to-be-sent audio stream from the application, where each to-be-sent audio stream is an audio stream to be played by a playback apparatus, and at least one to-be-sent audio stream includes a target audio stream; broadcast at least one piece of BIS data, where each piece of BIS data is configured to indicate one of at least one to-be-sent audio stream, at least one piece of BIS data includes target BIS data, and different pieces of BIS data correspond to different transmission channels.

It can be understood that at least one to-be-sent audio stream is obtained from the application, that is, a corresponding identifier is selected for each playback apparatus in at least one playback apparatus according to an input command from a user, and a corresponding to-be-sent audio stream is obtained from the application according to the at least one identifier selected by the user. For example, four audio stream identifiers are presented on the display apparatus, the user selects an audio stream 1 corresponding to an identifier 1 for a playback apparatus 1, and selects an audio stream 2 corresponding to an identifier 2 for a playback apparatus 2, then the display apparatus obtains the audio stream 1 and the audio stream 2 from the application.

Illustratively, as shown in FIG. 8, FIG. 8 is another process that a display apparatus broadcasts BIS data and playback apparatuses receive corresponding BIS data. Taking one display apparatus and three playback apparatuses as an example, the display apparatus obtains four identifiers (each identifier indicates an audio stream) from the application. A playback apparatus 1 determines a to-be-played audio stream 1, a playback apparatus 2 determines a to-be-played audio stream 2, and a playback apparatus 3 determines a to-be-played audio stream 3, according to an input command from a user. The display apparatus obtains three audio streams (i.e., an audio stream 1, an audio stream 2, and an audio stream 3) from the application, and broadcasts three pieces of BIS data corresponding to the three audio streams. The playback apparatus 1 receives BIS data 1 (corresponding to the audio stream 1) through a channel 1, the playback apparatus 2 receives BIS data 2 (corresponding to the audio stream 2) through a channel 2, and the playback apparatus 3 receives BIS data 3 (corresponding to the audio stream 3) through a channel 3.

In some embodiments of the disclosure, at least one to-be-sent audio stream is obtained from an application, each to-be-sent audio stream is an audio stream to be played by a playback apparatus, and at least one to-be-sent audio stream includes a target audio stream. At least one piece of BIS data is broadcasted, each piece of BIS data is configured to indicate one of at least one to-be-sent audio stream, at least one piece of BIS data includes target BIS data, and different pieces of BIS data correspond to different transmission channels. The display apparatus only obtains a to-be-sent audio stream when obtaining a video stream from an application, therefore, obtained data amount is reduced, and the efficiency of obtaining data is improved. In addition, the display apparatus does not need to process all audio streams, at least one piece of BIS data is obtained only by processing a to-be-processed audio stream, therefore, the resource consumption is reduced, and the data transmission efficiency between the display apparatus and the playback apparatus is improved.

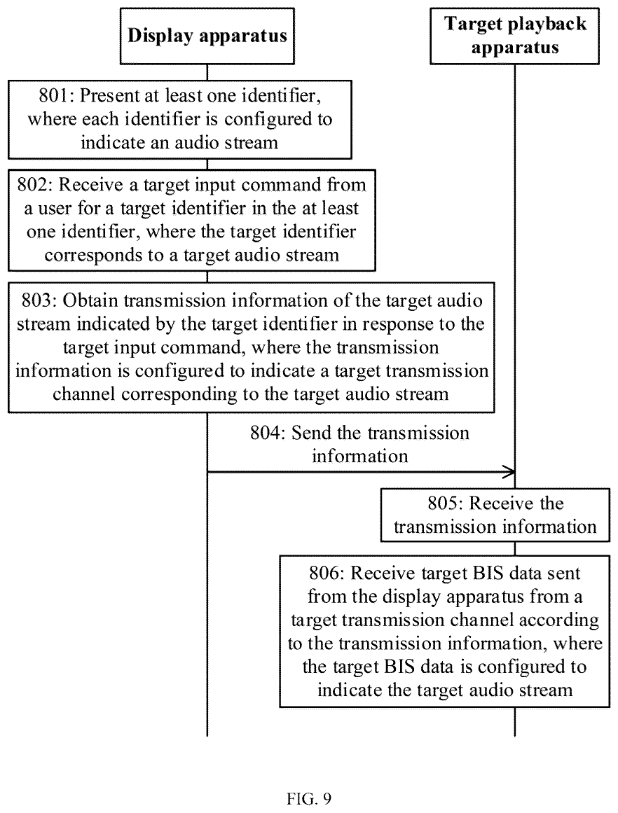

In embodiments of the disclosure, a data transmission method is provided. As shown in FIG. 9, the method includes following steps 801 to 806.

801: A display apparatus presents at least one identifier, and each identifier is configured to indicate an audio stream.

The at least one identifier is obtained from an application providing an audio stream.

802: The display apparatus receives a target input command from a user for a target identifier in the at least one identifier, and the target identifier corresponds to a target audio stream.

The target input command is configured to determine an audio stream to be played by a target playback apparatus.

803: The display apparatus obtains transmission information of the target audio stream indicated by the target identifier in response to the target input command, and the transmission information is configured to indicate a target transmission channel corresponding to the target audio stream.

804: The display apparatus sends the transmission information to a target playback apparatus.

805: The target playback apparatus receives the transmission information sent from the display apparatus.

806: The target playback apparatus receives target BIS data sent from the display apparatus from a target transmission channel according to the transmission information, and the target BIS data is configured to indicate the target audio stream.

In embodiments of the disclosure, the display apparatus presents at least one identifier, receives a target input command from a user for a target identifier in the at least one identifier, obtains transmission information of a target audio stream indicated by the target identifier in response to the target input command, and sends the transmission information to a target playback apparatus. The target playback apparatus receives the transmission information sent from the display apparatus, and receives target BIS data sent from the display apparatus from a target transmission channel according to the transmission information, and the target BIS data is configured to indicate a target audio stream. Therefore, an auxiliary apparatus for selecting an audio stream for a playback apparatus does not need to be added between the display apparatus and the playback apparatus, selection of the corresponding audio stream for the playback apparatus may be implemented on the display apparatus and operated on the display apparatus, which is also more in line with the user's habits, simple operation and good user experience.

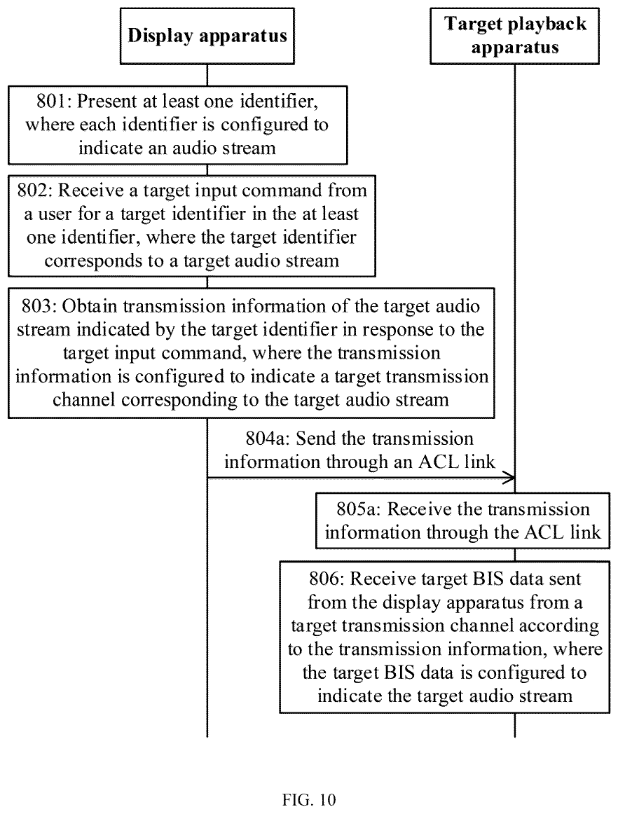

In some embodiments of the disclosure, in combination with FIG. 9, as shown in FIG. 10, the above step 804 may be implemented by the following step 804a. The above step 805 may be implemented by the following step 805a.

804a: The display apparatus sends the transmission information to the target playback apparatus through an ACL link between the display apparatus and the target playback apparatus.

805a: The target playback apparatus receives the transmission information sent from the display apparatus through the ACL link between the display apparatus and the target playback apparatus.

In embodiments of the disclosure, the transmission information is sent to the target playback apparatus through an asynchronous connection-oriented link (ACL) between the display apparatus and the target playback apparatus. Therefore, before the display apparatus broadcasts the BIS data, the transmission information corresponding to the target audio stream is sent to the target playback apparatus, so that the target playback apparatus can accurately obtain the target BIS data according to the corresponding target transmission channel in the transmission information, to obtain the target audio stream according to the target BIS data and ensure that the playback apparatus can accurately obtain the selected audio stream to be played. Moreover, compared with that the display apparatus broadcasts transmission information, and the playback apparatus needs to monitor a broadcast message all the time, because the transmission information is sent through the ACL link, the playback apparatus does not need to continuously monitor the broadcast channel. Therefore, power of the playback apparatus can be saved, available time of the playback apparatus can be extended, and the user experience can be optimized.

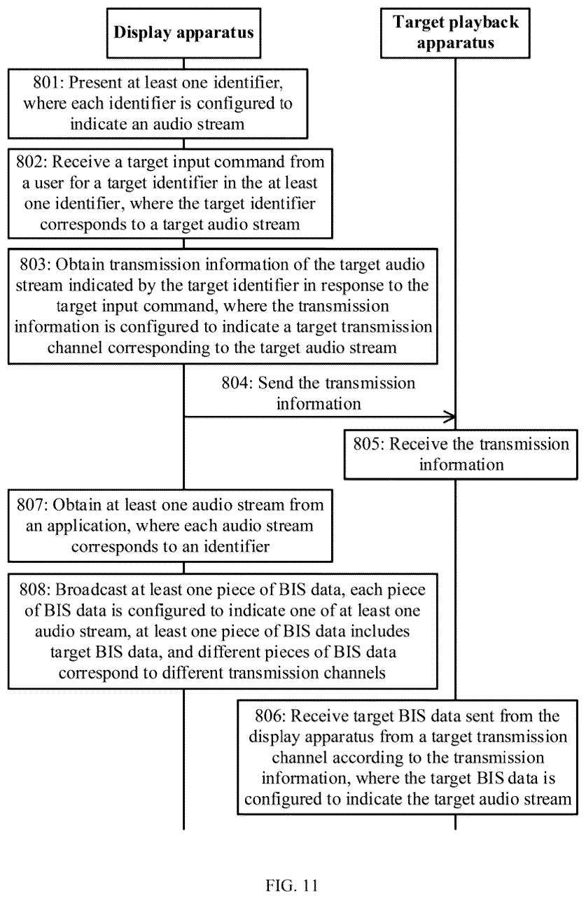

In some embodiments of the disclosure, in combination with FIG. 9, as shown in FIG. 11, the method further includes following steps 807 and 808.

807: The display apparatus obtains at least one audio stream from an application, and each audio stream corresponds to an identifier.

808: The display apparatus broadcasts at least one piece of BIS data, each piece of BIS data is configured to indicate one of at least one audio stream, at least one piece of BIS data includes target BIS data, and different pieces of BIS data correspond to different transmission channels.

Illustratively, referring to FIG. 6, the display apparatus broadcasts all of four pieces of BIS data corresponding to four obtained audio streams, and the playback apparatus receives an audio stream corresponding to the playback apparatus from a corresponding channel.

It should be noted that the execution order of step 801 to step 808 is determined according to actual requirements, which is not limited in embodiments of the disclosure. For example, the step 801 and the step 807 may be executed simultaneously, or the step 807 may be executed first and then the step 801 is executed.

In embodiments of the disclosure, at least one audio stream is obtained from an application, and each audio stream corresponds to an identifier. At least one piece of BIS data is broadcasted, each piece of BIS data is configured to indicate one of at least one audio stream, at least one piece of BIS data includes target BIS data, and different pieces of BIS data correspond to different transmission channels. All audio streams obtained from the application are broadcasted to at least one playback apparatus, and each of the at least one playback apparatus receives BIS data through a transmission channel in the received transmission information, so that the audio stream selected for each playback apparatus can be obtained, and each playback apparatus can play the selected audio stream.

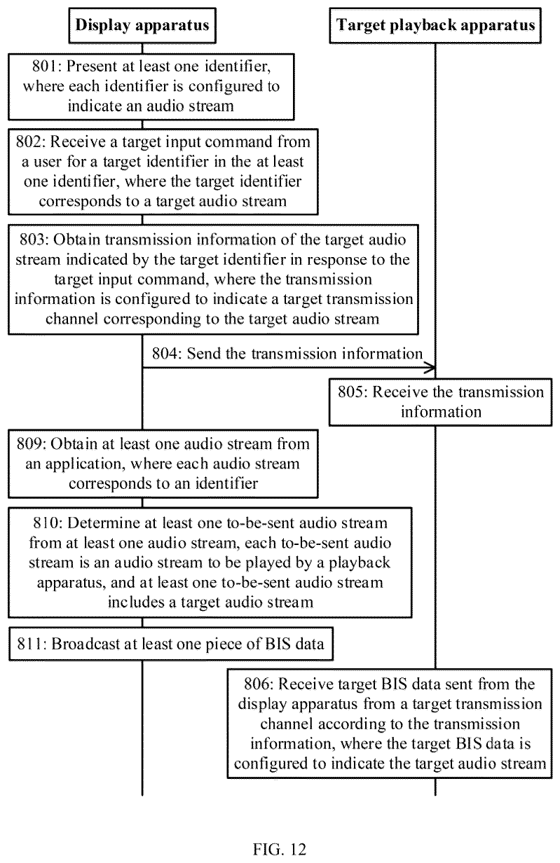

In some embodiments of the disclosure, in combination with FIG. 9, as shown in FIG. 12, the method further includes following steps 809 to 811.

809: The display apparatus obtains at least one audio stream from an application, and each audio stream corresponds to an identifier.

810: The display apparatus determines at least one to-be-sent audio stream from at least one audio stream, each to-be-sent audio stream is an audio stream to be played by a playback apparatus, and at least one to-be-sent audio stream includes a target audio stream.

811: The display apparatus broadcasts at least one piece of BIS data, each BIS data is configured to indicate one audio stream in the at least one to-be-sent audio stream, at least one piece of BIS data includes target BIS data, and different pieces of BIS data correspond to different transmission channels.

Illustratively, referring to FIG. 7, four audio streams are obtained by the display apparatus according to an input command from a user, three audio streams selected by the user for three playback apparatuses are selected from the four audio streams (that is, all audio streams are obtained from an application first, then audio streams are selected according to an input command from a user), three pieces of BIS data corresponding to the three audio streams are broadcasted, and a playback apparatus receives an audio stream corresponding to the playback apparatus from a corresponding channel.

In some embodiments of the disclosure, at least one audio stream is obtained from an application, and each audio stream corresponds to an identifier. At least one to-be-sent audio stream is determined from the at least one audio stream, each to-be-sent audio stream is an audio stream to be played by a playback apparatus, and at least one to-be-sent audio stream includes a target audio stream. At least one piece of BIS data is broadcasted, each piece of BIS data is configured to indicate one of at least one to-be-sent audio stream, at least one piece of BIS data includes target BIS data, and different pieces of BIS data correspond to different transmission channels. To broadcast at least one piece of BIS data corresponding to at least one audio stream, the display apparatus needs to process all audio streams in the at least one audio stream, and thus, the display apparatus side needs to process a large amount of data and a large number of resources are consumed. By obtaining an audio stream (a to-be-sent audio stream) to be played by at least one playback apparatus from at least one audio stream, the display apparatus only needs to process a to-be-processed audio stream to obtain at least one piece of BIS data, therefore, the resource consumption is reduced, and the data transmission efficiency between the display apparatus and the playback apparatus is improved.

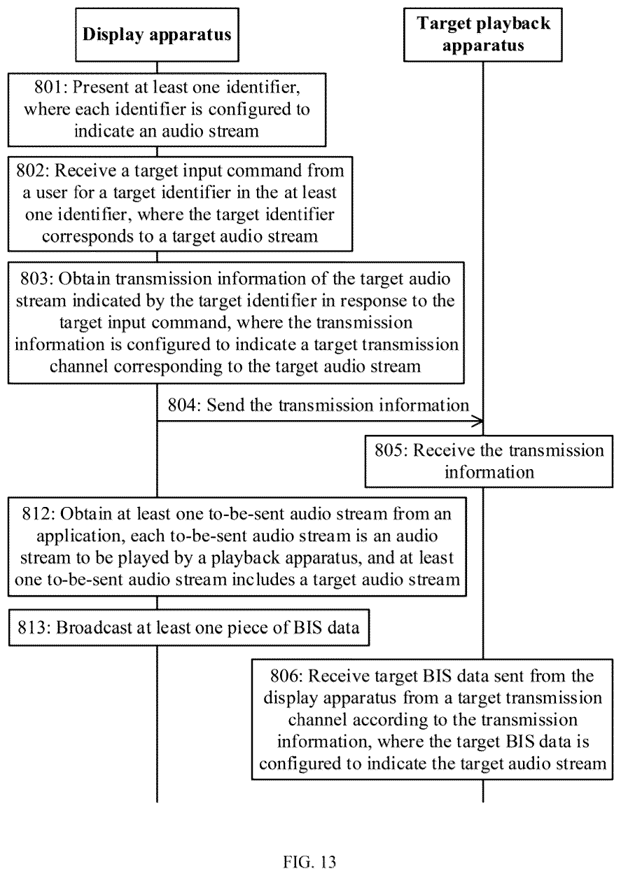

In some embodiments of the disclosure, in combination with FIG. 9, as shown in FIG. 13, the method further includes following steps 812 and 813.

812: The display apparatus obtains at least one to-be-sent audio stream from an application, each to-be-sent audio stream is an audio stream to be played by a playback apparatus, and at least one to-be-sent audio stream includes a target audio stream.

813: The display apparatus broadcasts at least one piece of BIS data.

Each piece of BIS data is configured to indicate one audio stream in the at least one to-be-sent audio stream, at least one piece of BIS data includes target BIS data, and different pieces of BIS data correspond to different transmission channels.

Illustratively, referring to FIG. 8, the display apparatus selects three audio streams selected by a user for three playback apparatuses from the four audio streams according to an input command from the user, (that is, audio streams selected by the user are obtained from an application), and broadcasts three pieces of BIS data corresponding to the three audio streams. The playback apparatus receives an audio stream corresponding to the playback apparatus from a corresponding channel.

In some embodiments of the disclosure, at least one to-be-sent audio stream is obtained from an application, each to-be-sent audio stream is an audio stream to be played by a playback apparatus, and at least one to-be-sent audio stream includes a target audio stream. At least one piece of BIS data is broadcasted, each piece of BIS data is configured to indicate one of at least one to-be-sent audio stream, at least one piece of BIS data includes target BIS data, and different pieces of BIS data correspond to different transmission channels. The display apparatus only obtains a to-be-sent audio stream when obtaining a video stream from an application, therefore, obtained data amount is reduced, and the efficiency of obtaining data is improved. In addition, the display apparatus does not need to process all audio streams, at least one piece of BIS data is obtained only by processing a to-be-processed audio stream, therefore, the resource consumption is reduced, and the data transmission efficiency between the display apparatus and the playback apparatus is improved.

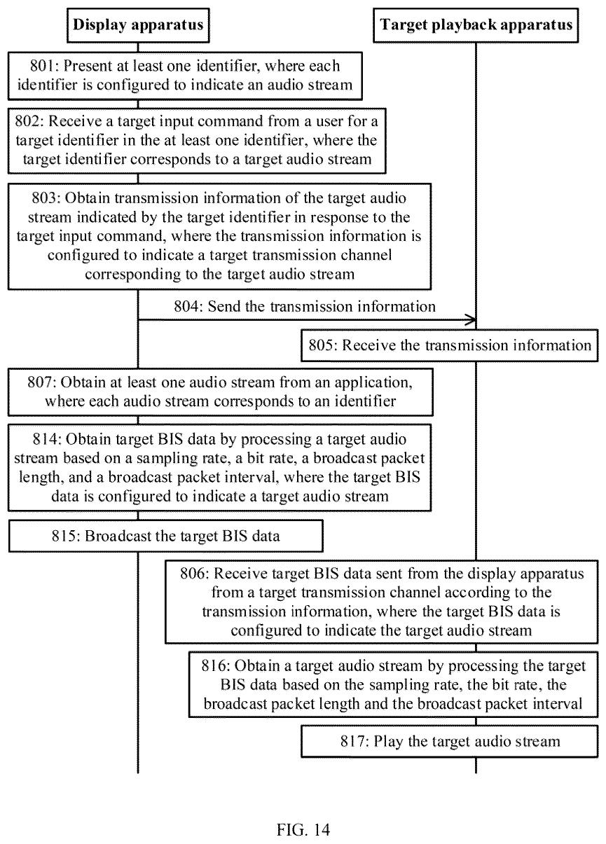

In some embodiments of the disclosure, in combination with FIG. 11, as shown in FIG. 14, the transmission information is further configured to indicate a sampling rate, a bit rate, a broadcast packet length and a broadcast packet interval. After the above step 807, the method further includes following steps 814 and 815. After the above step 806, the method further includes following steps 816 and 817.

814: The display apparatus obtains target BIS data by processing a target audio stream based on a sampling rate, a bit rate, a broadcast packet length, and a broadcast packet interval, and the target BIS data is configured to indicate a target audio stream.

815: The display apparatus broadcasts the target BIS data.

816: The target playback apparatus obtains a target audio stream by processing the target BIS data based on the sampling rate, the bit rate, the broadcast packet length and the broadcast packet interval.

817: The target playback apparatus plays the target audio stream.

In embodiments of the disclosure, the transmission information is further configured to indicate a sampling rate, a bit rate, a broadcast packet length, and a broadcast packet interval. A display apparatus and a target playback apparatus process a target audio stream based on a sampling rate, a bit rate, a broadcast packet length, and a broadcast packet interval. After receiving the target BIS broadcast packet, the target playback apparatus can accurately obtain the target audio stream according to the sampling rate, the bit rate, the broadcast packet length and the broadcast packet interval.

In some embodiments of the disclosure, after the above step 807, the method further includes following steps 818 and 819. After the above step 806, the method further includes following steps 820 and 821.

818: The display apparatus processes a target audio stream based on transmission parameters to obtain target BIS data.

819: The display apparatus broadcasts the target BIS data.

820: The target playback apparatus obtains a target audio stream by processing the target BIS data based on the transmission parameters.

The transmission parameters include a sampling rate, a bit rate, a broadcast packet length and a broadcast packet interval. A transmission channel has a corresponding relationship with a transmission parameter, and the transmission parameter can be determined according to the transmission channel. Transmission parameters of different transmission channels may be the same or different.

821: The target audio stream is played.

In embodiments of the disclosure, the display apparatus and the target playback apparatus process the target audio stream based on the transmission parameters. The transmission parameters of each transmission channel are preset, and the transmission parameters do not need to be sent each time in the transmission information, which ensures that the target playback apparatus can accurately obtain the target audio stream, while reducing messages to be sent, and the execution efficiency of message interaction is improved.

As also shown in FIG. 1, the control device may also be a device having a broadcast source scanning function, for example, may be a dedicated remote control device (control device 100) matched to the display apparatus 200, and may also be another terminal device (smart device 300) that communicates with the display apparatus 200, such as, a mobile terminal, a tablet computer, a smart wearable device, etc., which is limited in the disclosure.

The display apparatus 200 of embodiments of the disclosure may also be a smart speaker refrigerator with a display function, a curtain with a display function, a personal computer (PC), an electronic bulletin board, a wearable device, etc.

In some embodiments, when receiving the broadcast packet sent from the control device through the communicating device 220, the display apparatus 200 determines whether a broadcast packet includes a universally unique identifier (UUID) of a broadcast assistant service. The UUID is configured to indicate that the control device supports the broadcast assistant service, i.e., the control device has the ability to assist the display apparatus in discovering a broadcast source. In a case that the one or more processor 250 determines that the UUID of the broadcast assistant service is included in the broadcast packet, a broadcast source information link is established with that control device through the communicating device 220, and a broadcast source scanning result obtained by broadcast source scanning performed by the control device is received through the broadcast source information link.

Because the control device supports the broadcast assistant service, the control device can be used to perform broadcast source scanning to obtain a broadcast source scanning result. The broadcast source scanning result includes at least one broadcast source. Due to the mobility of the control device, a more comprehensive broadcast source scanning result can be obtained by moving the control device. After the control device obtains the broadcast source scanning result, the control device sends a broadcast source scanning result to the display apparatus through a broadcast source information link. The display apparatus receives the broadcast source scanning result obtained by the broadcast source scanning performed by the control device through the broadcast source information link.

In some embodiments, the one or more processor 250 is configured to execute computer instructions to cause the display apparatus to: in a case that the one or more processor 250 determines that a broadcast packet includes a UUID of the broadcast assistant service, establish a generic attribute protocol (GATT) link or an enhanced attribute protocol (EATT) link with the control device via the communicating device 220, and receive the broadcast source scanning result sent from the control device through the GATT link or the EATT link.

In some embodiments, the one or more processor 250 is configured to execute computer instructions to cause the display apparatus to: periodically receive the broadcast source scanning result sent from the control device through the broadcast source information link via the communicating device 220. After establishing the broadcast source information link, the control device may periodically perform broadcast source scanning, and send the broadcast source scanning result to the communicating device of the display apparatus. Correspondingly, the display apparatus 200 periodically receives the broadcast source scanning result sent from the control device through the broadcast source information link via the communicating device 220.

In some embodiments, the display apparatus 200 receives a scanning triggering operation input from the user via the user interface 280. The scanning triggering operation is configured to trigger the obtaining of the broadcast source scanning result. Optionally, the display apparatus may be provided with a physical button or a virtual button. The user may input the scanning triggering operation by triggering the physical button or the virtual button corresponding to the function of obtaining the broadcast source scanning result. Alternatively, the user may input the scanning triggering operation by voice input.

In some embodiments, the one or more processor 250 is further configured to execute the computer instructions to cause the display apparatus to: send request information for requesting the control device to perform broadcast source scanning through the broadcast source information link via the communicating device 220, and receive response information through the broadcast source information link, where the response information carries the broadcast source scanning result obtained by the broadcast source scanning.

In some embodiments, the request information further carries a scanning duration. The request information is configured to indicate the control device to perform broadcast source scanning during the scanning duration. The display apparatus 200 receives the response information through the broadcast source information link via the communicating device 220, where the response information carries the broadcast source scanning result obtained by the broadcast source scanning during the scanning duration.

In some embodiments, the display apparatus 200 presents each broadcast source in the broadcast source scanning result on a user interface via the display 260.

A selection operation for a target broadcast source on the user interface is received from the user input interface 280.

A control command is sent to at least one broadcast receiving apparatus connected with the display apparatus via the communicating device 220, where the control command is configured to control the at least one broadcast receiving apparatus to receive a broadcast signal of the target broadcast source.

In some embodiments, the broadcast packet is configured to request establishment of a Bluetooth connection with the display apparatus 200. The display apparatus 200 may also establish a Bluetooth connection with the control device via the communicating device 220 in response to the broadcast packet.

A control device according to embodiments of the disclosure includes a communicating device, configured to send a broadcast packet to a display apparatus 200 in a case that the control device supports a broadcast assistant service, where the broadcast packet carries a UUID of the broadcast assistant service.

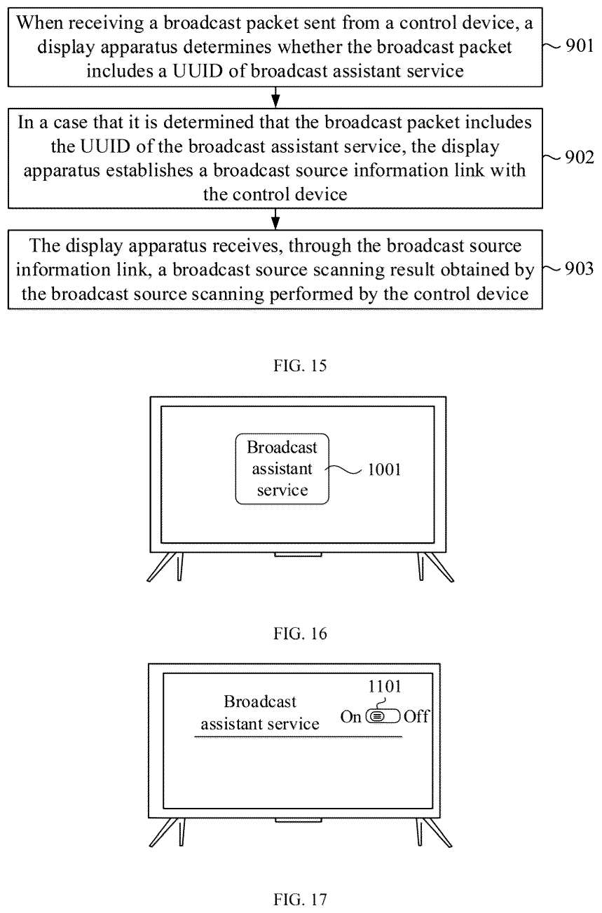

FIG. 15 is a seventh flowchart of a data transmission method for a display apparatus according to embodiments of the disclosure. The method includes following steps.

901: When receiving a broadcast packet sent from a control device, a display apparatus determines whether the broadcast packet includes a UUID of broadcast assistant service.

Illustratively, a user can determine whether it is necessary to assist the display apparatus in discovering the broadcast source through the control device according to the actual application scenario. For example, in a scenario that the broadcast source is hidden, there are many obstructions between the broadcast source and the display apparatus, the broadcast source is far away from the display apparatus, the capability of the display apparatus to scan the broadcast source is weak, or the function of the display apparatus to scan the broadcast source fails, the user may assist the display apparatus in discovering the broadcast source by triggering the control device. The control device can be provided with a physical button or a virtual button, and a user can trigger the physical button or the virtual button, to trigger the control device to assist the display apparatus in discovering the broadcast source. Taking the virtual button as an example, as shown in FIG. 16, FIG. 16 is a schematic diagram of a display interface of a control device according to embodiments of the disclosure. The display interface in FIG. 16 includes a broadcast assistant service button 1001. After the user clicks the broadcast assistant service button 1001, the control device is triggered to assist the display apparatus in discovering the broadcast source.

That is, the user can flexibly select whether to assist the display apparatus in discovering the broadcast source through the control device according to the actual application scenario. If it is necessary to assist the display apparatus in discovering the broadcast source through the control device, the control device is triggered to assist the display apparatus in discovering the broadcast source. If it is not necessary to assist the display apparatus in discovering the broadcast source through the control device, the display apparatus is selected in discovering the broadcast source, to increase flexibility of the broadcast source scanning.

The user can also set setting information for the control device, so that the display apparatus is assisted in discovering the broadcast source through the control device in any scenario. Illustratively, as shown in FIG. 17, FIG. 17 is a schematic diagram of another display interface of a control device according to embodiments of the disclosure. The display interface in FIG. 17 presents the setting information of the control device, and may include a broadcast assistant service switch 1101. When the user sets the broadcast assistant service switch 1101 to an on state, in any scenario, the display apparatus is assisted in discovering the broadcast source through the control device.

That is, the user can assist the display apparatus in discovering the broadcast source through the control device subsequently after one setting operation. There is no need to set each time, and the convenience of assisting the display apparatus in discovering the broadcast source through the control device is improved.

When it is determined that it is necessary to assist the display apparatus in discovering the broadcast source through the control device, the control device sends a broadcast packet to the display apparatus. The broadcast packet may include a UUID of the broadcast assistant service. The UUID is configured to indicate that the control device supports the broadcast assistant service, i.e., the UUID may indicate that the control device has the capability to assist the display apparatus in discovering the broadcast source.

In some embodiments, the broadcast packet may be a broadcast packet for requesting establishment of a Bluetooth connection with the display apparatus. In other embodiments, the broadcast packet may also be a broadcast packet dedicated to requesting the establishment of a broadcast information link, as long as the broadcast packet carries the UUID of the broadcast assistant service.

In some embodiments, the broadcast packet may also carry a device identifier of the control device, a media access control (MAC) address of the control device, etc.

902: In a case that it is determined that the broadcast packet includes the UUID of the broadcast assistant service, the display apparatus establishes a broadcast source information link with the control device.

When the display apparatus determines that the broadcast packet includes the UUID of the broadcast assistant service, it indicates that the control device supports the broadcast assistant service. A broadcast source information link is established between the display apparatus and the control device, so that the control device sends the broadcast source scanning result to the display apparatus through the broadcast source information link.

903: The display apparatus receives, through the broadcast source information link, a broadcast source scanning result obtained by the broadcast source scanning performed by the control device.

Because the control device supports the broadcast assistant service, the control device can be used to perform broadcast source scanning to obtain a broadcast source scanning result. The broadcast source scanning result includes at least one broadcast source. Due to the mobility of the control device, a more comprehensive broadcast source scanning result can be obtained by moving the control device.

After the control device obtains the broadcast source scanning result, the control device sends a broadcast source scanning result to the display apparatus through a broadcast source information link. The display apparatus receives the broadcast source scanning result obtained by the broadcast source scanning performed by the control device through the broadcast source information link.

Optionally, the broadcast source information link includes a generic attribute protocol (GATT) link or an enhanced attribute protocol (EATT) link. The control device sends the broadcast source scanning result to the display apparatus through the GATT link or the EATT link.

Correspondingly, the display apparatus receives the broadcast source scanning result sent from the control device through the GATT link or the EATT link.

In this embodiment, the display apparatus determines whether the broadcast packet includes the UUID of the broadcast assistant service to determine whether the control device supports the broadcast assistant service, establishes a broadcast source information link with the control device in a case that it is determined the broadcast packet includes the UUID of the broadcast assistant service, and receives the broadcast source scanning result obtained by the broadcast source scanning performed by the control device through the broadcast source information link. Because the display apparatus and the data transmission method (as shown in FIG. 15) of embodiments of the disclosure use the control device to perform the broadcast source scanning and send the broadcast source scanning result obtained by the broadcast source scanning to the display apparatus in a case that the control device supports the broadcast assistant service, embodiments of the disclosure can obtain a more comprehensive broadcast source scanning result by utilizing the mobility of the control device, to solve the problem that a broadcast source to be connected cannot be scanned due to the broadcast source scanning of the display apparatus.

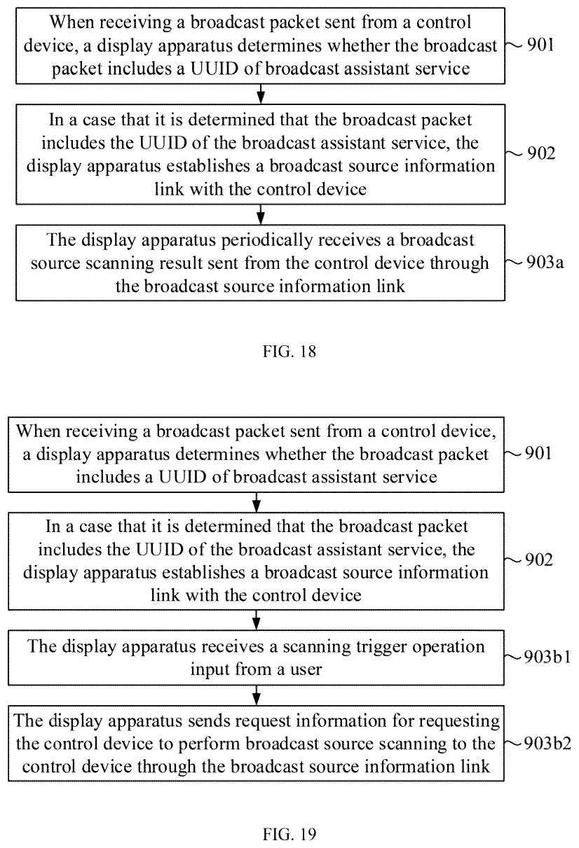

As an extension and refinement of above embodiments, the broadcast source scanning result may be obtained by, but not limited to, following embodiments. In one embodiment, referring to FIG. 18, an eighth flowchart of a data transmission method for a display apparatus according to embodiments of the disclosure is shown. As shown in FIG. 18, FIG. 18 is a description of an implementation of step 903 based on embodiments shown in FIG. 15.

903a: The display apparatus periodically receives a broadcast source scanning result sent from the control device through the broadcast source information link.

After establishing the broadcast source information link, the control device may periodically perform broadcast source scanning, and send the broadcast source scanning result to the display apparatus. The display apparatus periodically receives the broadcast source scanning result sent from the control device through the broadcast source information link. The specific period can be set by the user according to requirements, for example, the broadcast source scanning is once every minute, or, the broadcast source scanning is performed every hour, which is not limited by embodiments of the disclosure.

In this embodiment, the control device periodically perform the broadcast source scanning, periodically sending the broadcast source scanning result to the display apparatus through the broadcast source information link, so that the display apparatus can periodically know a condition of the broadcast source.

In another embodiment, referring to FIG. 19, a ninth flowchart of a data transmission method for a display apparatus according to embodiments of the disclosure is shown. As shown in FIG. 19, FIG. 19 is a description of another embodiment of step 903 based on embodiments shown in FIG. 15.

903b1: The display apparatus receives a scanning trigger operation input from a user.

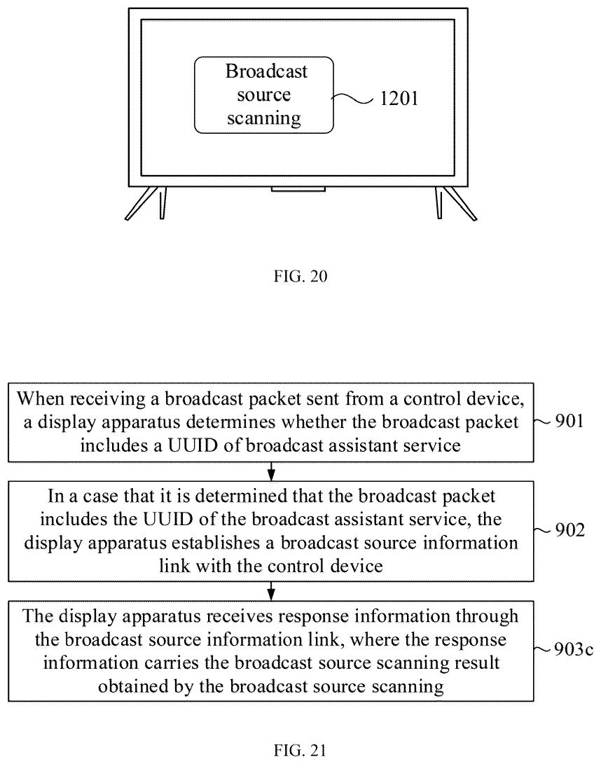

A user can input a scanning triggering operation on the display apparatus, and the scanning triggering operation is configured to triggering obtaining of a broadcast source scanning result. Optionally, the display apparatus may be provided with a physical button or a virtual button. The user may input the scanning triggering operation by triggering the physical button or the virtual button corresponding to the function of obtaining the broadcast source scanning result. Alternatively, the user may input the scanning triggering operation by voice input. As shown in FIG. 20, FIG. 20 is a schematic diagram of a display interface of a display apparatus according to embodiments of the disclosure. An obtaining broadcast source scanning result button 1201 is shown in FIG. 20. After the user triggers the obtaining broadcast source scanning result button 1201, step 903b2 is performed.

903b2: The display apparatus sends request information for requesting the control device to perform broadcast source scanning to the control device through the broadcast source information link.

The control device performs broadcast source scanning after receiving request information for requesting the control device to perform broadcast source scanning, obtains a broadcast source scanning result, and sends response information to the display apparatus through the broadcast source information link, where the response information carries the broadcast source scanning result obtained by performing the broadcast source scanning.

In some embodiments, each time the control device receives request information, the control device obtains a broadcast source scanning result by performing broadcast source scanning, and sends response information through the broadcast source information link, where the response information carries the broadcast source scanning result obtained by performing the broadcast source scanning.

In other embodiments, the request information may also carry a scanning duration. The request information is configured to indicate the control device to perform broadcast source scanning during the scanning duration. That is, after receiving the request information, the control device performs scanning according to the scanning duration carried in the request information, and sends response information through the broadcast source information link, where the response information carries a broadcast source scanning result obtained by performing broadcast source scanning during the scanning duration. For example, the scanning duration carried in the request information is from 2:05 p.m. to 2:15 p.m. The control device performs the broadcast source scanning and obtains the broadcast source scanning result during the duration corresponding to 2:05 p.m. to 2:15 p.m. The scanning duration may also be a preset length of time after the scanning request is received, for example, the scanning duration is 10 minutes. After receiving the scanning request, the control device continuously scans for 10 minutes to obtain the broadcast source scanning result.

In other embodiments, the request information may also carry the number of times of scanning and the interval time. After receiving the request information, the control device performs broadcast source scanning for many times. The time interval between two adjacent times is the interval time carried in the request information, for example, the number of times of scanning is 3, the interval time is 10 minutes, and the time length of each scanning is 1 minute by default, then after the control device receives the request information, broadcast source scanning with a duration of 1 minute is performed, and the broadcast source scanning result is sent to the display apparatus. At an interval of 10 minutes, the broadcast source scanning with the duration of 1 minute is performed again, the broadcast source scanning result is sent to the display apparatus, and the operations are repeated. After a total of 3 times of broadcast source scanning are performed, the request information is no longer responded to.

903b3: The display apparatus receives the response information through the broadcast source information link, where the response information carries the broadcast source scanning result obtained by performing the broadcast source scanning.

After receiving the response information carrying the broadcast source scanning result, the display apparatus obtains the broadcast source scanning result by parsing the response information.

In this embodiment, through a user inputting a scanning triggering operation on the display apparatus, the display apparatus is triggered to send request information for requesting the control device to perform broadcast source scanning to the control device through the broadcast source information link. The control device obtains a broadcast source scanning result by performing broadcast source scanning. The display apparatus receives response information through the broadcast source information link, where the response information carries the broadcast source scanning result obtained by the broadcast source scanning. That is, the broadcast source scanning is triggered to be performed in an active triggering mode on the display interface of the display apparatus when the user needs. Unnecessary scanning of the control device is avoided, and the energy is saved.

In another embodiment, referring to FIG. 21, a tenth flowchart of a data transmission method for a display apparatus according to embodiments of the disclosure is shown. As shown in FIG. 21, FIG. 21 is a description of another embodiment of step 903 based on embodiments shown in FIG. 15.

903c: The display apparatus receives response information through the broadcast source information link, where the response information carries the broadcast source scanning result obtained by the broadcast source scanning.

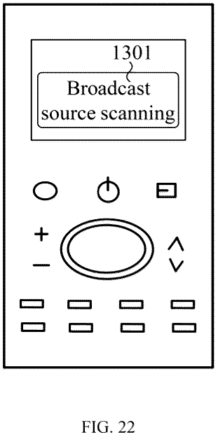

The user can actively trigger the control device to obtain the broadcast source scanning result. The control device receives a scanning triggering operation input from a user, where the scanning triggering operation is configured to trigger obtaining of a broadcast source scanning result. Illustratively, a physical or a virtual button may be provided on the control device. The user triggers the physical button or the virtual button corresponding to the broadcast source scanning function, to trigger the control device to perform broadcast source scanning to obtain a broadcast source scanning result, and receives, through the broadcast source information link, the response information carrying the broadcast source scanning result obtained by performing the broadcast source scanning. As shown in FIG. 22, FIG. 22 is a schematic diagram of a display interface of a control device according to embodiments of the disclosure. FIG. 22 includes a broadcast source scanning button 1301. A user triggers the scanning broadcast source button 1301, the control device performs broadcast source scanning to obtain a broadcast source scanning result, and sends response information carrying the broadcast source scanning result to the display apparatus through the broadcast source information link, so that the display apparatus receives the response information carrying the broadcast source scanning result through the broadcast source information link.

In this embodiment, after a user inputs a scanning triggering operation on the control device, the control device is triggered to obtain the broadcast source scanning result by performing the broadcast source scanning. The display apparatus receives, through the broadcast source information link, the response information carrying the broadcast source scanning result obtained by the broadcast source scanning. That is, the broadcast source scanning is triggered to be performed in an active triggering mode on a display interface of the control device by a user when necessary, therefore unnecessary scanning of the control device is avoided, and the energy is saved.

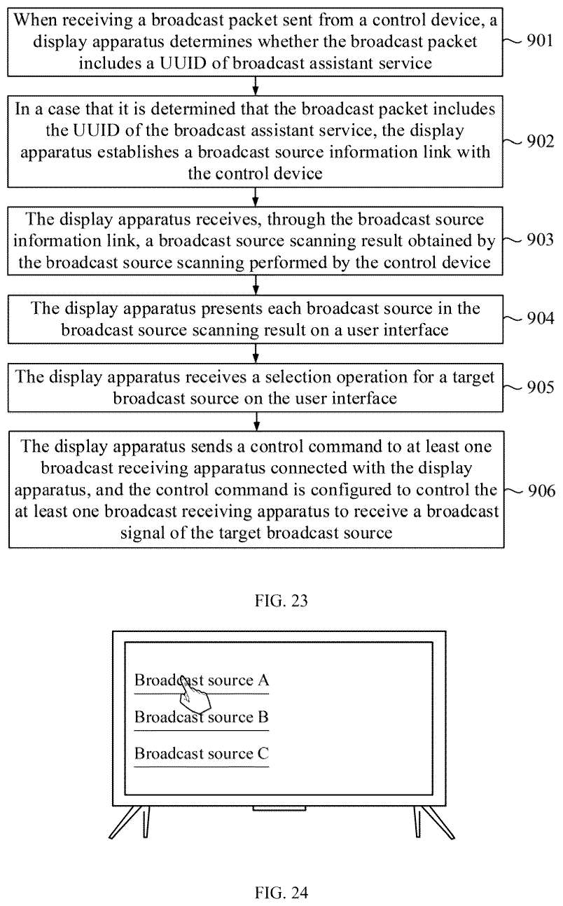

As an extension and refinement of above embodiments, after the display apparatus obtains the broadcast source scanning result through but not limited to the following embodiments, broadcast sources are presented to facilitate the user's selection of the broadcast sources. As shown in FIG. 23, FIG. 23 is based on embodiments shown in FIG. 15, and further includes following steps 904 to 906.

904: The display apparatus presents each broadcast source in the broadcast source scanning result on a user interface.

As shown in FIG. 24, it is assumed that the broadcast source scanning result includes three broadcast sources, namely, a broadcast source A, a broadcast source B, and a broadcast source C. The user selects the broadcast source A as a target broadcast source.

The user can select the target broadcast source on the display interface through the control device. The user can also control selection of the target broadcast source by voice input. If the display apparatus is a touch screen, the user can also select the target broadcast source by touching.

905: The display apparatus receives a selection operation for a target broadcast source on the user interface.

906: The display apparatus sends a control command to at least one broadcast receiving apparatus connected with the display apparatus, and the control command is configured to control the at least one broadcast receiving apparatus to receive a broadcast signal of the target broadcast source.

In this embodiment, the display apparatus presents each broadcast source in the broadcast source scanning result on the user interface, to be convenient for a user to select a target broadcast source. After the user selects the target broadcast source, the display apparatus sends a control command to at least one broadcast receiving apparatus connected with the display apparatus, to control the broadcast receiving apparatus to receive the broadcast signal of the target broadcast source, to enable broadcast receiving apparatuses to share broadcast signals from the same broadcast source.

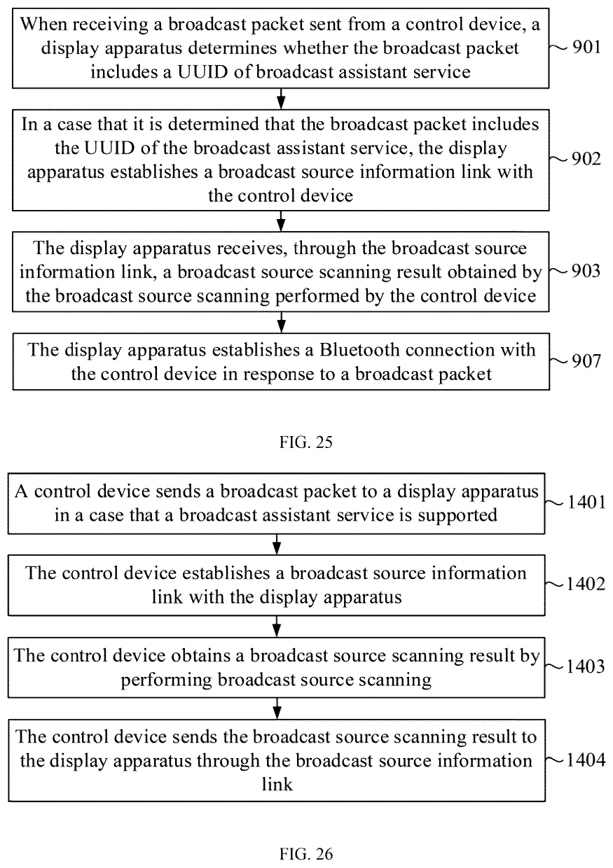

As an extension and refinement of the above embodiments, the broadcast packet is a broadcast packet for requesting establishment of a Bluetooth connection with the display apparatus. Furthermore, the method further includes establishing a Bluetooth connection between the control device and the display apparatus. As shown in FIG. 25, FIG. 25 is based on embodiments shown in FIG. 15, and further includes a step 907.

907: The display apparatus establishes a Bluetooth connection with the control device in response to a broadcast packet.

In this embodiment, the broadcast packet sent from the control device to the display apparatus is configured to request to establish a Bluetooth connection with the display apparatus. The display apparatus establishes the Bluetooth connection with the control device in response to the broadcast packet, to perform data transmission through the Bluetooth connection.

FIG. 26 is a thirteenth flowchart of a data transmission method for a control device according to embodiments of the disclosure. As shown in FIG. 26, the method includes following steps.

1401: A control device sends a broadcast packet to a display apparatus in a case that a broadcast assistant service is supported.

The broadcast packet carries a UUID of the broadcast assistant service.

In some embodiments, the broadcast packet may be a broadcast packet for requesting establishment of a Bluetooth connection with the display apparatus. In other embodiments, the broadcast packet may also be a broadcast packet dedicated to requesting the establishment of a broadcast information link, as long as the broadcast packet carries the UUID of the broadcast assistant service.

A user can determine whether it is necessary to assist the display apparatus in discovering a broadcast source through the control device according to an actual application scenario. For example, in a scenario that the broadcast source is hidden, there are many obstructions between the broadcast source and the display apparatus, the broadcast source is far away from the display apparatus, the capability of the display apparatus to scan the broadcast source is weak, or the function of the display apparatus to scan the broadcast source fails, the user may assist the display apparatus in discovering the broadcast source by triggering the control device. The control device can be provided with a physical button or a virtual button, and a user can trigger the physical button or the virtual button, to trigger the control device to assist the display apparatus in discovering the broadcast source.

That is, the user can flexibly select whether to assist the display apparatus in discovering the broadcast source through the control device according to the actual application scenario. If it is necessary to assist the display apparatus in discovering the broadcast source through the control device, the control device is triggered to assist the display apparatus in discovering the broadcast source. If it is not necessary to assist the display apparatus in discovering the broadcast source through the control device, the display apparatus is selected in discovering the broadcast source, to increase flexibility of the broadcast source scanning.

The user can also set setting information for the control device, so that the display apparatus is assisted in discovering the broadcast source through the control device in any scenario.

That is, the user can assist the display apparatus in discovering the broadcast source through the control device subsequently after one setting operation. There is no need to set each time, and the convenience of assisting the display apparatus in discovering the broadcast source through the control device is improved.

When it is determined that it is necessary to assist the display apparatus in discovering the broadcast source through the control device, the control device sends a broadcast packet to the display apparatus. The broadcast packet may include a UUID of the broadcast assistant service. The UUID is configured to indicate that the control device supports the broadcast assistant service, i.e., the UUID may indicate that the control device has the capability to assist the display apparatus in discovering the broadcast source.

1402: The control device establishes a broadcast source information link with the display apparatus.

1403: The control device obtains a broadcast source scanning result by performing broadcast source scanning.

1404: The control device sends the broadcast source scanning result to the display apparatus through the broadcast source information link.

In this embodiment, the control device sends a broadcast packet to the display apparatus in a case that the control device supports the broadcast assistant service, establishes a broadcast source information link with the display apparatus, obtains a broadcast source scanning result by performing broadcast source scanning, sends the broadcast source scanning result to the display apparatus through the broadcast source information link. Because the display apparatus and the data transmission method (as shown in FIG. 26) of embodiments of the disclosure use the control device to perform the broadcast source scanning and send the broadcast source scanning result obtained by the broadcast source scanning to the display apparatus in a case that the control device supports the broadcast assistant service, embodiments of the disclosure can obtain a more comprehensive broadcast source scanning result by utilizing the mobility of the control device, to solve the problem that a broadcast source to be connected cannot be scanned due to the broadcast source scanning of the display apparatus.

In some embodiments, the disclosure provides a computer readable non-transitory storage medium, where the computer readable storage medium stores computer programs, the computer programs, when executed by a computing device, causes the computing device to implement the method of any of above embodiments.

In some embodiments, the disclosure provides a computer program product, where the computer program product, when run on a computer, causes the computer to implement the method of any of above embodiments.

For the convenience of explanation, the above description has been made in combination with specific embodiments. However, the above example discussion is not intended to be exhaustive or to limit embodiments to the specific forms disclosed above. Numerous modifications and variations can be obtained in light of the above teachings. The above embodiments are chosen and described in order to better explain the principles and practical applications, to enable those skilled in the art to better utilize the described embodiments and various variant embodiments suitable for specific uses.

What is claimed is:

1. A display apparatus, comprising:
a display, configured to present an image from a broadcast system and/or a network, and/or present a user interface;
a user input interface, configured to receive a command from a user;
a communicating device, configured to communicate with an external device;
a memory, configured to store computer instructions and data associated with the display and the communicating device; and
one or more processor, connected with the display, the user input interface, the communicating device and the memory, and configured to execute the computer instructions to cause the display apparatus to:
in response to a target input command received from the user input interface, obtain transmission information of a target audio stream indicated by a target identifier, wherein the transmission information is configured to indicate a target transmission channel corresponding to the target audio stream; and
send the transmission information to a target playback apparatus, so that the target playback apparatus receives target broadcast isochronous stream, BIS, data broadcasted by the display apparatus from the target transmission channel according to the transmission information, wherein the target BIS data is configured to indicate the target audio stream, the display is configured to present at least one identifier, each identifier is configured to indicate an audio stream, and the at least one identifier is obtained from an application providing an audio stream;
wherein the user input interface is configured to receive a target input command from the user for the target identifier in the at least one identifier, and the target input command is configured to determine an audio stream to be played by the target playback apparatus.

2. The display apparatus according to claim 1, wherein the one or more processor is configured to execute the computer instructions to cause the display apparatus to:
send the transmission information to the target playback apparatus through an asynchronous connection-oriented link, ACL, between the display apparatus and the target playback apparatus.

3. The display apparatus according to claim 1, wherein the one or more processor is further configured to execute the computer instructions to cause the display apparatus to:
obtain at least one audio stream from the application, wherein each audio stream corresponds to one identifier; and
broadcast at least one piece of BIS data, wherein each piece of BIS data is configured to indicate one of the at least one audio stream, the at least one piece of BIS data comprises the target BIS data, and different pieces of BIS data correspond to different transmission channels.

4. The display apparatus according to claim 1, wherein the one or more processor is further configured to execute the computer instructions to cause the display apparatus to:
obtain at least one audio stream from the application, wherein each audio stream corresponds to one identifier; determine at least one to-be-sent audio stream from the at least one audio stream, wherein each to-be-sent audio stream is an audio stream to be played by a playback apparatus, and the at least one to-be-sent audio stream comprises the target audio stream; broadcast at least one piece of BIS data, wherein each piece of BIS data is configured to indicate one of the at least one to-be-sent audio stream, the at least one piece of BIS data comprises the target BIS data, and different pieces of BIS data correspond to different transmission channels;
or,
obtain at least one to-be-sent audio stream from the application, wherein each to-be-sent audio stream is an audio stream to be played by a playback apparatus, the at least one to-be-sent audio stream comprises the target audio stream; broadcast at least one piece of BIS data, wherein each piece of BIS data is configured to indicate one of the at least one to-be-sent audio stream, the at least one piece of BIS data comprises the target BIS data, and different pieces of BIS data correspond to different transmission channels.

5. The display apparatus according to claim 1, wherein the transmission information is further configured to indicate a sampling rate, a bit rate, a broadcast packet length, and a broadcast packet interval; and
the one or more processor is further configured to execute the computer instructions to cause the display apparatus to:
obtain the target BIS data by processing the target audio stream based on the sample rate, the bit rate, the broadcast packet length, and the broadcast packet interval.

6. The display apparatus according to claim 1, wherein the one or more processor is further configured to execute the computer instructions to cause the display apparatus to:
upon receiving a broadcast packet sent from a control device, determine whether the broadcast packet comprises a universally unique identifier, UUID, of a broadcast assistant service; and
in a case that the one or more processor determines that the broadcast packet comprises the UUID of the broadcast assistant service, establish a broadcast source information link with the control device via the communicating device, and receive a broadcast source scanning result through the broadcast source information link, wherein the broadcast source scanning result is obtained by broadcast source scanning performed by the control device.

7. The display apparatus according to claim 6, wherein the one or more processor is configured to execute the computer instructions to cause the display apparatus to:
in the case the one or more processor determines that the broadcast packet comprises the UUID of the broadcast assistant service, establish a generic attribute protocol, GATT, link or an enhanced attribute protocol, EATT, link with the control device via the communicating device, and receive the broadcast source scanning result sent from the control device through the GATT link or the EATT link.

8. The display apparatus according to claim 6, wherein the one or more processor is configured to execute the computer instructions to cause the display apparatus to:
periodically receive the broadcast source scanning result sent from the control device through the broadcast source information link via the communicating device.

9. The display apparatus according to claim 6, wherein the one or more processor is further configured to execute the computer instructions to cause the display apparatus to:
receive a scanning triggering operation input from the user via the user input interface, wherein the scanning triggering operation is configured to trigger obtaining of the broadcast source scanning result; and
send request information for requesting the control device to perform broadcast source scanning through the broadcast source information link via the communicating device, and receive response information through the broadcast source information link, wherein the response information carries the broadcast source scanning result obtained by the broadcast source scanning.

10. The display apparatus according to claim 9, wherein the request information further carries a scanning duration; the request information is configured to indicate the control device to perform the broadcast source scanning during the scanning duration; and
the one or more processor is further configured to execute the computer instructions to cause the display apparatus to:
receive the response information through the broadcast source information link via the communicating device, wherein the response information carries the broadcast source scanning result obtained by the broadcast source scanning during the scanning duration.

11. The display apparatus according to claim 6, wherein the one or more processor is further configured to execute the computer instructions to cause the display apparatus to:
present each broadcast source in the broadcast source scanning result on the user interface via the display;
receive a selection operation for a target broadcast source on the user interface via the user input interface; and
send a control command to at least one broadcast receiving apparatus connected with the display apparatus via the communicating device, wherein the control command is configured to control the at least one broadcast receiving apparatus to receive a broadcast signal of the target broadcast source.

12. The display apparatus according to claim 6, wherein the broadcast packet is configured to request to establish a Bluetooth connection with the display apparatus; and
the one or more processor is further configured to execute the computer instructions to cause the display apparatus to:
establish a Bluetooth connection with the control device via the communicating device in response to the broadcast packet.

13. A playback apparatus, comprising:
one or more processor, configured to:
receive transmission information sent from a display apparatus, wherein the transmission information is configured to indicate a target transmission channel corresponding to a target audio stream, the transmission information is transmission information of the target audio stream indicated by a target identifier obtained by the display apparatus in response to a target input command, the target input command is an input command received by the display apparatus from a user for a target identifier in at least one identifier, the target input command is configured to determine an audio stream to be played by a target playback apparatus, the at least one identifier is obtained by the display apparatus from an application providing an audio stream, and each identifier is configured to indicate an audio stream; and
receive target broadcast isochronous stream, BIS, data sent from the display apparatus from the target transmission channel according to the transmission information, wherein the target BIS data is configured to indicate the target audio stream.

14. The playback apparatus according to claim 13, wherein the one or more processor is configured to:
receive the transmission information sent from the display apparatus through an asynchronous connection-oriented link, ACL, between the display apparatus and the target playback apparatus.

15. The playback apparatus according to claim 13, wherein the transmission information is further configured to indicate a sampling rate, a bit rate, a broadcast packet length, and a broadcast packet interval; the playback apparatus further comprises a player;
the one or more processor is further configured to obtain the target audio stream by processing the target BIS data based on the sampling rate, the bit rate, the broadcast packet length, and the broadcast packet interval; and
the player is configured to play the target audio stream.

16. A control device, comprising:
a communicating device, configured to send a broadcast packet to a display apparatus in a case that the control device supports a broadcast assistant service, wherein the broadcast packet carries a universally unique identifier, UUID, of the broadcast assistant service;
establish a broadcast source information link with the display apparatus;
obtain a broadcast source scanning result by performing broadcast source scanning; and
send the broadcast source scanning result to the display apparatus through the broadcast source information link.
